(19) United States
(12) Patent Application Publication
(10) Pub. No.: US 2005/0185232 A1
(43) Pub. Date: Aug. 25, 2005

(54) Volume hologram recording photosensitive composition and its use

(76) Inventors: Takashi Teranishi, Nara-ken (JP); Akihiko Sato, Osaka-fu (JP); Shigeru Mikami, Hyogo-ken (JP); Hiroki Ando, Osaka-fu (JP)

Correspondence Address: WENDEROTH, LIND & PONACK, L.L.P., 2033 K STREET N. W., SUITE 800, WASHINGTON, DC, 20006-1021, US

(21) Appl. No.: 11/064,498

(22) Filed: Feb. 24, 2005

(30) Foreign Application Priority Data
Feb. 24, 2004 (JP) 2004-048195
Aug. 11, 2004 (JP) 2004-234615

(51) Int. Cl. G03H 1/02

(52) U.S. Cl. 359/3

(57) ABSTRACT

Disclosed is a photosensitive composition for volume hologram recording which shows excellent interference fringe record and a volume hologram recording medium having lighter weight and excellent storage stability. The invention is directed to a volume hologram recording photosensitive composition comprising: (a) a compound having at least one active methylene group in one molecule or a compound having at least two active methine groups in one molecule; (b) a compound containing in one molecule two or more groups which are nucleophilicly added by a carbanion generating from an active methylene group or an active methine group; (c) a Michael-reaction catalyst; (d) a photopolymerizable compound; and (e) a photopolymerization initiator composition.

### FIELD OF THE INVENTION

The present invention relates to volume hologram recording medium for obtaining an excellent interference fringe recording.

### BACKGROUND OF THE INVENTION

Recent developments of information technology have been requiring high capacities of photo-recording medium like optical disks. For the optical disks such as CD and DVD as photo-recording medium, data are recorded in a storage layer with less than 10 μm thick by a planar-recording system bit-by-bit. These storage capacities are 650 mega byte for CD and 4.7 giga byte for DVD (single sited one layer type).

On holographic recording, in contrast, digital information is two-dimensionally converted into one piece of page data, which is stacked several pages together at a time to record as volume holograms. Mass capacity of terabyte order can be theoretically achieved by recording interference fringes in thickness (depth) direction as the fringes of recording information.

On the holographic recording, storage capacities of recording medium increase in proportion to thickness (depth) of recording layer (photosensitive layer). Therefore, in recording medium (volume hologram recording medium) using for holographic recording, a recording layer having a thickness of from about 200 μm to 1 mm is required in comparison to conventional optical recording medium. In the volume holographic recording medium, because of three-dimensional recording in a thickness direction of recording layer, the thickness uniformity of recording layer is also severely required in comparison to the conventional planar optical recording medium. Namely, the volume hologram recording medium is required to have a thicker recording layer and be more uniform in thickness than the conventional optical recording medium.

For a manufacturing method with a constant thickness, Japanese Unexamined Patent Publication No. 7230 (1999) discloses volume hologram recording medium characterized in a recording layer contains binder resins. The binder resins help to produce film formation of the recording layer and the uniformity of thickness. However, binder resins generally make viscosity high and, even at a higher temperature, does not reduce viscosity so much drop, which can cause undesirable nonuniformity portions in the recording layer (imperfect defoaming, etc.). The nonuniformity portions must be eliminated because it gives adverse effects on recording data and reproducing data.

As a manufacturing method of volume hologram recording medium, a photopolymerizable or thermo-setting liquid resin is injected into a space of recording layer for forming recording layer to give three-dimension recording medium (volume hologram recording medium) as described in Japanese Unexamined Patent Publication No. 5368 (2001). The method is useful for forming recording layer with a uniform thickness. These resins in the method are required to be low viscose for ease of application process.

Japanese Unexamined Patent Publication 11 (1999)-352303 discloses a process for producing an optical article, such as holographic recording medium and the like, in which matrix precursor is mixed with photoacitive monomer and then cured to form matrix as it is. In this method, the polymerization reaction of the matrix precursor is separated from a polymerization reaction of the photoactive monomer which is conducted during data recordation. For the polymerization reaction of the matrix precursor, the specification exemplifies a copolymerization of mercaptan with epoxy. The copolymerization is generally associated with exothermic reaction producing much heat energy and control of reaction is very difficult in many cases. The photosensitive composition for volume hologram recording medium is required to have high sensitivity to light for recording information, but the recording medium obtained by the above method does not have sufficient photosensitivity.

Japanese Unexamined Patent Publication Hei 10 (1998)-105030 discloses a recording medium composed of an active layer changing refractive index depending on radiation, wherein the active layer comprises a matrix material functioning as a host for photochemical monomer material responding with radiation by photopolymerization and the matrix material is produced by in-situ polymerization of polyfunctional oligomer having a molecular weight of more than 1,000 and 70% of the total monomer material is a monofunctional. The recording medium is different from the present invention in that an oligomer having a molecular weight of more than 1,000 is used. The use of the oligomer keeps the material with relatively high viscosity and therefore may cause inclusion of air foams. The recording medium of this publication does not have sufficient sensitivity.

### OBJECT OF THE INVENTION

The object of the present invention is to provide a photosensitive composition for volume hologram recording which shows excellent interference fringe record and a volume hologram recording medium having lighter weight and excellent storage stability.

### SUMMARY OF THE INVENTION

The present invention provides a volume hologram recording photosensitive composition comprising:
(a) a compound having at least one active methylene group in one molecule or a compound having at least two active methine groups in one molecule;
(b) a compound containing in one molecule two or more groups which are nucleophilicly added by a carbanion generating from an active methylene group or an active methine group;
(c) a Michael-reaction catalyst;
(d) a photopolymerizable compound; and
(e) a photopolymerization initiator composition.

The present invention also provides a volume hologram recording photosensitive composition comprising:
(a) a compound having at least one active methylene group in one molecule or a compound having at least two active methine groups in one molecule;
(c) a Michael-reaction catalyst;
(e) a photopolymerization initiator composition; and
(f) a compound containing in one molecule two or more groups which are at least one sort of an acrylate group and a methacrylate group. The compound (f) may preferably have fluorene structure.

The photopolymerization initiator composition (e) may contain a compound selected from the group consisting of titanocene compound, diaryliodonium salt, triazine type compound and triarylsulfonium salt. The Michael-reaction catalyst (c) may contain one selected from the group consisting of alkaline metal hydroxide, alkaline metal alkoxide, onium salt, tertiary amine, guanidine, amidine and tertiary phosphine.

The present invention additionally provide a process for producing a volume hologram recording medium, comprising the following steps:
an injection step wherein the above volume hologram recording photosensitive composition is injected into a defined space having a given depth, and
a pre-reaction step wherein the composition is heated to addition-react either the compound (a) with the compound (b) or the compound (a) with a portion of the compound (f).

The present invention further provides a process for producing a volume hologram recording medium, comprising the following steps:
a coating step wherein the above volume hologram recording photosensitive composition is coated on one of a pair of substrates to form a photosensitive composition layer,
a laminating step wherein the other paired substrate is laminated on the photosensitive composition layer, and
a pre-reaction step wherein the composition is heated to addition-react either the compound (a) with the compound (b) or the compound (a) with a portion of the compound (f).

In addition, the present invention provides a volume hologram recording medium which comprises a volume hologram recording layer; a first and a second substrates sandwiching the recording layer; a side member fixing peripheries of the recording layer and keeping a given distance between the first and the second substrates, wherein the first and the second substrates are resin substrates; each of the first and the second substrates has at least one inorganic thin layer on its surface facing said recording layer or the rear surface; and the volume hologram recording layer is a viscosity-increased layer of photosensitive composition for volume hologram recording by light exposure or heating.

The volume hologram recording layer is obtained by a photosensitive composition for volume hologram recording, the photosensitive composition comprises:
(a) a compound having at least one active methylene group in one molecule or a compound having at least two active methine groups in one molecule;
(b) a compound containing in one molecule two or more groups which are nucleophilicly added by a carbanion generating from an active methylene group or an active methine group;
(c) a Michael-reaction catalyst;
(d) a photopolymerizable compound; and
(e-1) a photopolymerization initiator composition,
   wherein the recording layer is preferably a viscosity-increased layer resulted from a reaction of compound (a) and compound (b) by heating.

The photosensitive composition for volume hologram recording is preferably increased in viscosity by a radical polymerization by light exposure or heating.

Moreover, the photopolymerizable compound (d) is preferably a radical polymerizable compound with one or more ethylenically unsaturated double bonds in a molecule. The compound (b) is preferably a monomer with fluorene skeleton.

A volume hologram recording layer is obtained by a photosensitive composition for volume hologram recording, the photosensitive composition comprises:
(a) a compound having at least one active methylene group in one molecule or a compound having at least two active methine groups in one molecule;
(c) a Michael-reaction catalyst;
(e-1) a photopolymerization initiator composition; and
(f) a compound containing in one molecule two or more groups which are at least one sort of an acrylate group and a methacrylate group, wherein the recording layer is a viscosity-increased layer resulted from a reaction of compound (a) and part of compound (f) by heating.

Further, a volume hologram recording layer is obtained by a photosensitive composition for volume hologram recording, the photosensitive composition comprises:
(d-1) a cationic polymerizable compound;
(d-2) a radical polymerizable compound;
(e-2) a photopolymerization initiator composition including; (i) a photopolymerization initiator; being sensitized by a laser beam or a light having excellent coherence which has a specific wavelength for interference fringe exposure, to polymerize at least one sort of cationic polymerizable compound (d-1) and radical polymerizable compound (d-2); and (ii) a pre-reaction initiator; being sensitized by a light having the other wavelength than one using in pre-reaction for interference fringe exposure, to polymerize a radical polymerizable compound (d-2),
wherein the recording layer is a viscosity-increased layer resulted from a polymerization of compound (d-2) by a light having the other wavelength than one using in interference volume exposure process.

The photopolymerization initiator composition (e-2) preferably includes diaryliodonium salt; sensitizer; and one or more compounds selected from titanocene compound, monoacylphosphine oxide, bisacylphosphine oxide, and combination of bisacylphosphine oxide and α-hydroxyketone.

The inorganic thin layer includes a film of metal oxide. Further, the inorganic thin layer is films of one or more metal oxide preferably selected from the group consisting of silicon oxide, aluminum oxide, and magnesium oxide.

The present invention also provides a manufacturing process for volume hologram recording medium. As an embodiment of manufacturing method, the process for volume hologram recording medium comprises:
injection process which a photosensitive composition for volume hologram recording is injected into a space defined by a pair of a first substrate and a second substrate, and a side member keeping a given distance between the first and the second substrates being sandwiched; and a pre-reaction process in which the photosensitive composition for volume hologram recording is exposed by a light or by heating,
wherein each of the first and the second substrates has at least one inorganic thin layer on its surface facing the recording layer or the rear surface; and the photosensitive composition for volume hologram recording is increased in viscosity of by light exposure or heating.

The photosensitive composition for volume hologram recording is the one that can be preferably increased in viscosity due to a radical polymerization by light exposure or heating.

As another embodiment of manufacturing method for volume hologram recording medium, the photosensitive composition for volume hologram recording comprises:
(a) a compound having at least one active methylene group in one molecule or a compound having at least two active methine groups in one molecule;
(b) a compound containing in one molecule two or more groups which are nucleophilicly added by a carbanion generating from an active methylene group or an active methine group;
(c) a Michael-reaction catalyst;
(d) a photopolymerizable compound; and
(e-1) a photopolymerization initiator composition,
wherein the photosensitive composition for volume hologram recording is increased in viscosity by heating to react the compound (a) and the compound (b).

The compound (b) is preferably a monomer with fluorene skeleton.

As another embodiment of manufacturing method for volume hologram recording medium, the photosensitive compound for volume hologram recording comprises:
(a) a compound having at least one active methylene group in one molecule or a compound having at least two active methine groups in one molecule;
(c) a Michael-reaction catalyst;
(e-1) a photopolymerization initiator composition; and
(f) a compound containing in one molecule two or more groups which are at least one sort of an acrylate group and a methacrylate group,
wherein the photosensitive compound is increased in viscosity due to a reaction of compound (a) and part of compound (f) by heating.

In the manufacturing method, after pre-reaction, the method further comprises an interference fringe exposure process for photopolymerizable compound (d) or remaining compound (f) to polymerize by a laser beam or a light having excellent coherence which has a specific wavelength.

As another embodiment of manufacturing method for volume hologram recording medium, the photosensitive composition for volume hologram recording comprises:
(d-1) a cationic polymerizable compound;
(d-2) a radical polymerizable compound;
(e-2) a photopolymerization initiator composition including; (i) a photopolymerization initiator; being sensitized by a laser beam or a light having excellent coherence which has a specific wavelength for interference fringe exposure, to polymerize at least one sort of cationic polymerizable compound (d-1) and radical polymerizable compound (d-2); and (ii) a pre-reaction initiator; being sensitized by a light having the other wavelength than one using in the pre-reaction for interference fringe exposure, to polymerize a radical polymerizable compound (d-2) in the pre-reaction,
wherein the photosensitive compound is increased in viscosity due to a polymerization of radical polymerizable compound (d-2) by a light having the other wavelength than one using in interference fringe exposure process.

The photopolymerization initiator composition (e-2) preferably includes diaryliodonium salt; sensitizer; and one or more compounds selected from titanocene compound, monoacylphosphine oxide, bisacylphosphine oxide, and combination of bisacylphosphine oxide and α-hydroxyketone.

In the manufacturing method, after pre-reaction, the method further comprises an interference fringe exposure process for at least one sort of cationic polymerizable compound (d-1) and radical polymerizable compound (d-2) to polymerize by a laser beam or a light having excellent coherence which has a specific wavelength.

The inorganic thin layer is preferably a film of metal oxide. Further, the inorganic thin layer is preferably one or more films of metal oxide preferably selected from silicon oxide, aluminum oxide, and magnesium oxide.

The present invention further provides volume hologram recording medium obtained from the manufacturing method for the volume hologram recording medium.

The volume hologram recording medium by the present invention is light weight and excellent impact-shock resistance because it consists of resin substrate instead of glass one. The recording layer composed of the recording medium presents an excellent uniformity and interference fringe recording. The present invention provides the improvement of storage stability of volume hologram recording medium.

### BRIEF DESCRIPTION OF THE DRAWINGS

FIG. 1 is a perspective view illustrating a basic structure for volume hologram recording medium;

FIG. 2 is a perspective view illustrating another basic structure for the volume hologram recording medium;

FIG. 3 is a perspective view illustrating another basic structure for the volume hologram recording medium;

FIG. 4 is a schematic diagram for manufacturing evaluation teat sheet in Examples; and

FIG. 5 is a schematic diagram of optical system for optical characteristic evaluation of hologram.

### DETAILED DESCRIPTION OF THE INVENTION

The process reaching to the present invention is explained briefly. As a manufacturing method for volume hologram recording medium, a recording layer is formed by injection of a photosensitive composition for volume hologram recording into a given space and a method for increasing viscosity by a reaction of the photosensitive composition. In this method, the photosensitive composition for volume hologram recording is of a low viscosity at the injection, and then by the method for increasing viscosity, becomes to a high viscosity so as to maintain a solid form upon interference infringe exposure for recording information in the recording layer for volume hologram recording medium. This method can avoid a trapped-foam problem stemmed from a high viscosity during the injection of photosensitive composition for volume hologram recording. Furthermore, the method can avoid deterioration of recording precision stemmed from a high viscosity upon interference fringe exposure for recording data in a recording layer for volume hologram recording medium. The present invention firstly provides a photosensitive composition and a process for producing a volume hologram recording medium, in which the photosensitive composition is pre-reacted to increase viscosity. In the present invention, the photosensitive composition has low viscosity and is easily injected into a defined space for a volume hologram layer. However, after pre-reaction, the composition has sufficient viscosity for recording and fixing interference fringe upon exposure of interference fringe. Without the pre-reaction, the composition remains low viscosity and after recording interference fringe, polymerized polymer is moved within the composition so as not to fix the recorded information sufficiently.

Another aspect of the present invention, although conventional volume hologram recording medium is prepared mainly with glass substrates, it is preferable to construct volume hologram recording medium with resin substrates because of light weight and improvement of impact-shock resistance. However, when volume hologram recording medium with resin substrates such as polycarbonate is prepared, after injection of a photosensitive composition for volume hologram recording, in the method for increasing viscosity, a desired reaction to a high viscosity is achieved or conducted, if any, white turbidity and war page were occurred by the photosensitive composition. This causes recording performance to be deteriorated or impossible upon interference infringe exposure. The reasons are that polycarbonate substrates are inferior to glass substrates in oxygen cut-off and water cut-off, chemical resistance for organic solvents and monomers. The reason for not increasing viscosity is thought that oxygen and water in the air penetrate polycarbonate substrates to affect reversely increase in viscosity of the photosensitive composition for volume hologram recording.

The present invention solved this problem also and made a defoam process easy and provided an excellent precision of interference fringe recording, and volume hologram recording medium with an excellent carry-out performance. The volume hologram recording medium by the present invention will be sequentially explained.

The volume hologram recording photosensitive composition of the present invention comprises (a) a compound having at least one active methylene group in one molecule or a compound having at least two active methine groups in one molecule, (b) a compound containing in one molecule two or more groups which are nucleophilicly added by a carbanion generating from an active methylene group or an active methine group, (c) a Michael-reaction catalyst, (d) a photopolymerizable compound; and (e) a photopolymerization initiator composition.

The compound (a) is a compound having at least one active methylene group in one molecule or a compound having at least two active methine groups in one molecule (compound (a)), which easily generate carbanion. Examples of the compound (a) include reaction products of an alcohol with a carboxylic acid containing active methylene and/or active methine group and/or its derivative. Examples of derivatives of carboxylic acid containing active methylene and/or active methine group include carboxylic acid ester, carboxylic acid anhydride and the like. Particularly, examples of carboxylic acid containing methylene group and its derivative include acetoacetic acid, malonic acid, cyanoacetic acid, and derivatives thereof such as ester. And also, carboxylic acid containing active methine group and its derivative particularly include methane tricarboxylic acid, and derivatives thereof, such as ester as described in EP 0310011.

The active methylene group is a methylene group being sandwiched by two carbonyl groups, which is in a state with excess electrons by the carbonyl groups to generate easily carbanion by releasing proton. The active methine group is a methine group being sandwiched by three carbonyl groups, which is in a state with excess electrons by the carbonyl groups to generate easily carbanion by releasing proton.

The alcohols to be reacted with the carboxylic acid containing active methylene and/or active methine group can be either monoalcohol or polyhydric alcohol, but polyhydric alcohols have to be used for the compound (a) having at least two methine groups in one molecule. Examples of the monoalcohols are methanol, ethanol, propanol, butanol and the like. The polyvalent alcohols are compounds containing two or more hydroxyl groups in a molecule, for example, ethylene glycol, diethylene glycol, propylene glycol, tetramethylene glycol, 1,6-henanediol, neopentyl glycol, trimethylolpropane, glycerin, pentaerythritol, 1,4-cyclohexanedimethanol, 4,4′-isopropylidenedicyclohexanol, bis(hydroxymethyl)tricyclo[5, 2, 1, O]decane, 1,3,5-tris(2-hydroxyethyl)cyanuric acid, isopropylidenebis(3, 4-cyclohexanediol) and the like.

Also, as the compound (a), for example, there are reaction products of polyhydric amine compound and diketene. The polyhydric amines are compounds containing two or more amino groups in a molecule, for example, ethylenediamine, 1,3-diaminopropane, 1,4-diaminobutane, 1, 6-hexanediamine, 1,12-diaminododecane, 1,2-diaminocyclohexane, phenylenediamine, piperazine, 2,6-diaminotoluene, diethyltoluenediamine, N,N′-bis(2-aminopropyl)ethylenediamine, N,N′-bis(3-aminopropyl)-1, 3-propanediamine and the like.

On the other hand, as the compound (a), for example, there are reaction products of isocyanate with carboxylic acid containing active methylene and/or active methine group and/or its derivative. As the isocyanate compound, for example, there are tolylene diisocyanate, 4,4′-diphenylmethane diisocyanate, xylene diisocyanate, hexamethylene diisocyanate, lysine diisocyanate, 4,4′-methylenebis (cyclohexylisocyanate), methylcyclohexane diisocyanate, 1,3-(isocyanate-methyl) cyclohexane, isophoronediisocyanate, trimethylhexamethylene diisocyanate, norbornene diisocyanate, and a dimmer, trimmer or adduct compounds of the above isocyanate.

As the compound (a), the above compound can be used separately or as two or more combinations thereof. In case where the compound (a) is one that contains at least one methylene group in one molecule, the active methylene group has two active hydrogens, which can react with two of the compounds (b) to conduct crosslinking with merely one methylene group.

The present invention provides a significant effect by using a compound (a) containing in one molecule two or more groups which are at least one sort of an active methylene group and an active methine groups, giving nucleophilic addition to the compound (b). As the compound giving nucleophilic addition to the compound (b), there are amine compound, mercaptan compound and the like, other than the above compound (a), However, when amine compound instead of a compound (a) is used, a dark reaction often occurs between the amine compound and diaryliodnium salts which is used for photopolymerization initiator composition (e). And, the reaction causes deterioration on storage stability of photosensitive composition for volume hologram recording, and of volume hologram recording medium.

Also, when the mercaptan compound instead of a compound (a) is used, the mercaptan compound reacts with the compound (b) only if there exists equivalent amount of functional groups concerning to Michael addition. On the other hand, when the compound (a) by the present invention is applied, in particular, the compound containing active methylene group is applied, one active methylene group can react two groups for nucleophilic addition contained in the compound (b). This can present a matrix with a high crosslinking density, which secures advantageously interference fringe retention (recording retention).

Moreover, amine compound and mercaptan compound have a very high reactivity at room temperature. Therefore, photosensitive composition containing the compounds give difficulties in lowering viscosity by heating in the injection process. It needs to control the viscosity even at room temperature to meet injection, which largely constrains viscosity design on photosensitive composition. On the other hand, in use of the photosensitive composition by the present invention comprising a compound (a) containing active methylene group, the photosensitive composition which is capable to inject under heating can be obtained by changing content of Michael reaction catalyst. This gives a wide design range of viscosity control on a photosensitive composition.

The compound (b) containing in one molecule two or more groups which are nucleophilicly added by a carbanion generating from an active methylene group or an active methine group is a compound which is nucleophilicly added by carbanion generated in the compound (a). The compound includes a compound containing in one molecule two or more groups which are at least one sort of an acrylate group and a methacrylate group. Specific example is diacrylmonomer, dimethacrylmonomer or monomer having both an acryl group and a methacryl group, which has fluorene skeleton. Representative example are 9,9-bis(4-(meth)acryloyloxyphenyl)fluorene, 9,9-bis(4-(meth)acryloyloxymethoxyphenyl)fluorene, 9,9-bis(4-(2-meth)acryloyloxyethoxy)phenyl)fluorene, 9,9-bis(4-(2-meth)acryloyloxypropoxy)phenyl)fluorene, 9,9-bis(4-(3-meth)acryloyloxypropoxy)phenyl)fluorene, 9,9-bis(4-(meth)acryloyloxydimethoxyphenyl)fluorene, 9,9-bis(4-(meth)acryloyloxydiethoxyphenyl)fluorene, 9,9-bis(4-(meth)acryloyloxydipropoxyphenyl)fluorene, 9,9-bis(4-(meth)acryloyloxytrimethoxyphenyl)fluorene, 9,9-bis(4-(meth)acryloyloxytriethoxyphenyl)fluorene, 9,9-bis(4-(meth)acryloyloxytripropoxyphenyl)fluorene, 9,9-bis(4-(meth)acryloyloxytetramethoxyphenyl)fluorene, 9,9-bis(4-(meth)acryloyloxytetraethoxyphenyl)fluorene, 9,9-bis(4-(meth)acryloyloxytetrapropoxyphenyl)fluorene, 9,9-bis(4-(meth)acryloyloxy-3-methylphenyl)fluorene, 9,9-bis(4-(meth)acryloyloxymethoxy-3-methylphenyl)fluorene, 9,9-bis(4-(2-(meth)acryloyloxyethoxy)-3-methylphenyl)fluorene, 9,9-bis(4-(2-(meth)acryloyloxypropoxy)-3-methylphenyl)fluorene, 9,9-bis(4-(3-(meth)acryloyloxypropoxy)-3-methylphenyl)fluorene 9,9-bis(4-(meth)acryloyloxydimethoxy-3-methyl phenyl)fluorene, 9,9-bis(4-(meth)acryloyloxydiethoxy-3-methylphenyl)fluorene, 9,9-bis(4-(meth)acryloyloxydipropoxy-3-methylphenyl)fluorene, 9,9-bis(4-(meth)acryloyloxytrimethoxy-3-methylphenyl)fluorene, 9,9-bis(4-(meth)acryloyloxytriethoxy-3-methylphenyl)fluorene, 9,9-bis(4-(meth)acryloyloxytripropoxy-3-methylphenyl)fluorene, 9,9-bis(4-(meth)acryloyloxytetramethoxy-3-methylphenyl)fluorene, 9,9-bis(4-(meth)acryloyloxytetraethoxy-3-methylphenyl)fluorene, 9,9-bis(4-(meth)acryloyloxytetrapropoxy-3-methylphenyl)fluorene, 9,9-bis(4-(meth)acryloyloxy-3-ethylphenyl)fluorene, 9,9-bis(4-(meth)acryloyloxymethoxy-3-ethylphenyl)fluorene, 9,9-bis(4-(2-meth)acryloyloxyethoxy-3-ethylphenyl)fluorene, 9,9-bis(4-(2-meth)acryloyloxypropoxy-3-ethyl phenyl)fluorene, 9,9-bis(4-(3-meth)acryloyloxypropoxy-3-ethylphenyl)fluorene, 9,9-bis(4-(meth)acryloyloxydimethoxy-3-ethylphenyl)fluorene, 9,9-bis(4-(meth)acryloyloxydiethoxy-3-ethyl phenyl)fluorene, 9,9-bis(4-(meth)acryloyloxydipropoxy-3-ethylphenyl)fluorene, 9,9-bis(4-(meth)acryloyloxytrimethoxy-3-ethylphenyl) fluorene, 9,9-bis(4-(meth)acryloyloxytriethoxy-3-ethylphenyl)fluorene, 9,9-bis(4-(meth)acryloyloxytripropoxy-3-ethylphenyl)fluorene, 9,9-bis(4-(meth)acryloyloxytetramethoxy-3-ethylphenyl)fluorene, 9,9-bis(4-(meth)acryloyloxytetraethoxy-3-ethyl phenyl)fluorene, 9,9-bis(4-(meth)acryloyloxytetrapropoxy-3-ethylphenyl)fluorene, 9,9-bis(4-(meth)acryloyloxy-3-propylphenyl)fluorene, 9,9-bis(4-(meth)acryloyloxymethoxy-3-propylphenyl)fluorene, 9,9-bis(4-(2-(meth)acryloyloxyethoxy)-3-propylphenyl)fluorene, 9,9-bis(4-(2-(meth)acryloyloxypropoxy)-3-propylphenyl)fluorene, 9,9-bis(4-(3-(meth)acryloyloxypropoxy)-3-propylphenyl)fluorene, 9,9-bis(4-(meth)acryloyloxydimethoxy-3-propylphenyl)fluorene, 9,9-bis(4-(meth)acryloyloxydiethoxy-3-propylphenyl)fluorene, 9,9-bis(4-(meth)acryloyloxydipropoxy-3-propylphenyl)fluorene, 9,9-bis(4-(meth)acryloyloxytrimethoxy-3-propylphenyl)fluorene, 9,9-bis(4-(meth)acryloyloxytriethoxy-3-propylphenyl)fluorene, 9,9-bis(4-(meth)acryloyloxytripropoxy-3-propylphenyl)fluorene, 9,9-bis(4-(meth)acryloyloxytetramethoxy-3-propylphenyl)fluorene, 9,9-bis(4-(meth)acryloyloxytetraethoxy-3-propyl phenyl)fluorene, 9,9-bis(4-(meth)acryloyloxytetrapropoxy-3-propylphenyl)fluorene, 9,9-bis(4-(meth)acryloyloxy-(2-hydroxy)propoxyphenyl)fluorene, 9,9-bis(4-(meth)acryloyloxy-(2-hydroxy)propoxy-3-methylphenyl)fluorene, 9,9-bis(4-(meth)acryloyloxy-(2-hydroxy)propoxyethoxyphenyl)fluorene, bisphenolfluorenedihydroxyacrylate, i.e., acrylic acid adduct of 9,9-bis(4-hydroxyphenyl)fluorene with glycidyl ether (Nippon Steel Chemical Co., Ltd.), bisphenolfluorenedihydroxymethacrylate (Nippon Steel Chemical Co., Ltd.), bisphenoxyethanolfluorenediacrylate (BPEF-A: Osaka Gas Co., Ltd.), bisphenoxyethanolfluorenedimethacrylate (BPEF-MA: Osaka Gas Co., Ltd.), bisphenoxyethanolfluorenediepoxyacrylate (BPEF-GA: Osaka Gas Co., Ltd.), bisphenolfluorenediepoxyacrylate (BPF-GA: Osaka Gas Co., Ltd.), biscresolfluorenediepoxyacrylate (BCF-GA: Osaka Gas Co., Ltd.) and the like.

An ester of the above polyvalent alcohol and (meth)acrylic acid can be used as the compound (b) including ethylene glycol di(meth)acrylate, triethylene glycol di(meth)acrylate, tetraethylene glycoldi(meth)acrylate, 1,3-butylene glycol di(meth)acrylate, trimethylolpropane tri(meth)acrylate, 1,4-butanediol di(meth)acrylate, neopentylglcol di(meth)acrylate, 1,6-hexanediol di(meth)acrylate, pentaerythritol di(meth)acrylate, pentaerythritol tri(meth)acrylate, pentaerythritol tetra(meth)acrylate, glycerol di(meth)acrylate, tricyclodecanedimethanol di(meth)acrylate, di pentaerythritol poly(meth)acrylate, 2,2-bis(4-(meth)acryoxypolyethoxyphenyl)propane, bis(4-(meth)acryoxydiethoxyphenyl)propane; ethylene oxide or propylene oxide adduct of the polyvalent alcohol and the like.

As the compound (b), the monomer with fluorene skeleton is preferable. As the compound (b), the compound above mentioned can be used separately or as two or more combinations thereof.

The compound (a) and (b) are conducted in pre-reaction by heating before recording interference fringe for nucleophilic addition of the compound (a) to the compound (b), to polymerize, thereby increasing in viscosity to a high level for maintaining a solid form. The compound (a) and (b) contain in such amount that a ratio of equivalent number of active methylene group and/or active methine group to equivalent number of group to be nucleophilicly added by carbanion (e.g. acrylate group and/or methacrylate group) is 1:0.3 to 1:3, preferably 1:0.8 to 1:1.2.

Michael reaction catalyst (c) is necessary for generating carbanion (enolate anion) by increasing acidity of methylene (methine) proton in the function of electron absorptive groups such as two carbonyl groups adjacent to methylene (methine). Examples of the Michael reaction catalyst (c) are: alkali metal hydroxide, such as sodium hydroxide, potassium hydroxide; alkali metal alkoxide, such as sodium methoxide, potassium ethoxide; onium salt, such as tert-ammonium halide, tert-ammonium carbonate, tert-ammonium hydroxide, tert-ammonium tetrahydroborate; triamine, such as tetramethylguanidine, 1, 8-diazabicyclo[5,4,0]undecene-7, diazabicyclo[4,3,0]nonen-5; guanidine; amidine; and triphosphine, such as triphenylphosphine; and the like. As co-catalysts for the Michel reaction catalyst, an epoxy compound as known by Japanese Unexamined Patent Publication No. 173262 (1995) can also be used.

As a cationic portion of the onium salt, examples are: quaternary-ammonium cation, such as tetrabutylammonium cation, tetramethylammonium cation, tetrapropylammonium cation, tetrahexylammonium cation, tetraoctylammonium cation, tetradecylammonium cation, tetrahexadecylammonium cation, triethylhexylammonium cation, 2-hydroxylethyltrimethylammonium (choline)cation, methyltrioctylammonium cation, cetyltrimethylammonium cation, 2-chloroetyltrimethylammonium cation, methylpyridniumammonium cation; quaternary phosphonium cation, such as tetrabutylphosphonium cation; tertiary sulfonium cation, such as trimethylsulfonium cation; and the like. Quaternary ammonium cation available in various kinds is preferable.

As an anionic portion of the onium salt, examples are: halide anion such as fluoride anion, chloride anion, bromide anion, iodide anion; carboxylate anion, such as acetic acid anion, benzoic acid anion, salicylic acid anion, maleic acid anion, phthalic acid anion; sulfonate anion, such as methanesulfonic acid anion, p-toluenesulfonic acid anion, dodecylbenzenesulfonic acid anion; sulfate anion, such as sulfuric acid anion, metosulfuric acid anion; nitrate anion, such as nitric acid anion; and phosphate anion such as phosphoric acid anion, di-t-butyl phosphoric acid anion; and the like. In addition, hydroxide anion, carbonate anion, tetrahydroborate anion and the like may also be exemplified. In view of curability, halide anion and carboxylate anion are preferable.

Examples of the onium salts are tetrabutylammonium chloride, tetrabutylammonium fluoride, tetrabutylammonium fluoride, tetraethylammonium bromide, diethyldibutylammonium chloride, octyltrimethylammonium bromide, tetrabutylammonium acetate, dioctyidimethylammonium salicylate, benzyllauryldimethylammonium chloride, 2-hydroxyethyltrimethylammonium chloride, tetraethylphosphonium chloride, tetraethylphosphonium bromide, tetrabutylphosphonium chloride, and trimetylphosphonium chloride.

As the compound (c), the compound above mentioned can be used separately or as two or more combinations thereof.

In the present invention, compound (a), compound (b), and Michael reaction catalyst (c) are constituents for forming matrix of volume hologram recording layer, and they may be referred as “matrix forming constituent”.

The photopolymerizable compound (d) is a compound which can be photopolymerized on exposure to a laser having specific wavelength or a light having excellent coherence. In the interference fringe exposure process, by irradiation of a laser having specific wavelength or a light having excellent coherence, the photopolymerizable compound (d) is polymerized to record interference fringe. The photopolymerizable compound (d) includes both radical polymerizable compound and cationic polymerizable compound. The radical polymerizable compound and cationic polymerizable compound can be used separately or as two or more mixtures thereof.

The cationic polymerizable compound which can be used as a photopolymerizable compound (d) is a compound which cationically polymerizes by the function of Bronsted acid or Lewis acid generated from decomposition of cationic photopolymerization initiator. Such cationic polymerizable compounds are described in, for example, Chemtech. Oct. p. 624, (1980), J. V. Crivello; Japanese Unexamined Patent Publication No. 149783 (1987), and Japan Adhesive Journal Vol. 26, No. 5, p. 179-187, (1990).

Examples of the cationic polymerizable compounds include diglycerol polyglycidyl ether, pentaerythritol polyglycidyl ether, 1,4-bis(2, 3-epoxypropoxyperfluoroisopropyl)cyclohexane, sorbitol polyglycidyl ether, trimethylolpropane polyglycidyl ether, resorcin diglycidyl ether, 1,6-hexanediol diglycidyl ether, polyethylene glycol diglycidyl ether, phenyl glycidyl ether, p-t-butylpheyl glycidyl ether, diglycidyl adipate, diglycidyl o-phthalate, dibromophenyl glycidyl ether, dibromoneopenthyl glycol diglycidyl ether, 1,2,7,8-diepoxyoctane, 1,6-dimethylolperfluorhexane glycidyl ether, 4,4′-bis(2,3-epoxypropoxyperfluoroisopropyl) diphenyl ether, 3,4-epoxycyclohexylmetyl-3′,4′-epoxycyclohexane carboxylate, 3,4-epoxycyclohexyloxirane, 1,2,5,6-diepoxy-4,7-methanoperhydroindene, 2-(3,4-epoxycyclohexyl)-3′,4′-epoxy-1,3-dioxane-5-spirocyclohexane, 1,2-ethlenedioxy-bis(3,4-epoxycyclohexylmethane, 4′,5′-epoxy-2′-methylcyclphexylmethyl-4,5-epoxy-2-methylcyclohexane carboxylate, ethylene glycol-bis(3,4-epoxycyclohexyl carboxylate)adipate, bis(3,4-epoxycyclohexylmethyl)adipate, epoxidized polybutadiene, di-2,3-epoxycyclopentyl ether, vinyl-2-chloroethyl ether, vinyl-n-butyl ether, triethylene glycol divinyl ether, 1,4-cyclohexanedimethanol divinyl ether, trimethylolethane trivinyl ether, vinylglycidyl ether, compounds represented by the formulas: 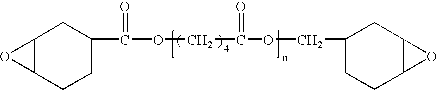
wherein n is an integer of 1 to 5, and 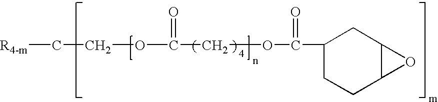
wherein m is an integer of 3 or 4, R is ethyl or a hydroxymethyl group, and n is as defined above in the cycloaliphatic compounds. These cationic polymerizable compounds can be used separately or as two or more combinations thereof.

The radical polymerizable compound which can be used as photopolymerizable compound (d) is a compound which contains at least one ethylenically unsaturated double bond in one molecule. Examples of the radical polymerizable compounds include methyl methacrylate, hydroxyethyl methacrylate, lauryl acrylate, N-acryloyl morpholine, 2-ethylhexylcarbitol acrylate, isobonyl acrylate, methoxypropylene glycol acryrate, 1,6-hexanediol diacrylate, tetraethylene glycol diacrylate, trimethylolpropane triacrylate, pentaerythritol triacrylate, pentaerythritol tetraacrylate, acrylamide, methacrylamide, styrene, 2-bromostyrene, phenyl acrylate, 2-phenoxyethyl acrylate, 2,3-acryoxyethyl naphthalene dicarboxylic acid (acryloxyethyl) monoester, methylphenoxyethyl acrylate, nonylphenoxyethyl acrylate, β-acryloxyethyl hydrogen phthalate, phenoxy polyethylene glycol acrylate, 2,4,6-tribromophenyl acrylate, 2-methacryloxyethyl diphenic acid monoester, benzyl acrylate, 2,3-dibromopropyl acrylate, 2-hyddroxy-3-phenoxypropyl acrylate, 2-naphthyl acrylate, N-vinylcarbazole, 2-(9-carbazolyl)ethyl acrylate, triphenylmethyl thioacrylate, 2-(tricyclo[5,2,10^{2,6}]dibromodecylthio)ethyl acrylate, S-(1-naphtylmethyl)thioacrylate, dicyclopentanyl acrylate, methylene bisacrylamide, polyethylene glycol diacrylate, trimethylolpropanetriacrylate, pentaerythritoltriacrylate, (2-acryoxyethyl)(3-acryloxypropyl-2-hydroxy)diphenate, (2-acryloxyethyl)(3-acryloxypropyl-2-hydroxy) 2,3-naphthalenedicarboxylate, (2-acryloxyethyl)(3-acryloxypropyl-2-hydroxy) 4,5-phenanthrenedicarboxylate,dibromoneopenthyl glycol diacrylate, dipentaerythritol hexaacrylate, 1,3-bis-[2-acryloxy-3-(2,4,6-tribromophenoxy)propoxy]benzene, diethylene dithioglycol diacrylate, 2,2-bis(4-acryoxyethoxyphenyl)propane, bis(4-acryloxydiethoxyphenyl)methane, bis(4-acryloxydiethoxy-3,5-dibromophenyl)methane, 2,2-bis(4-acryloxyethoxyphenyl)propane, 2,2-bis(4-acryloxydiethoxyphenyl)propane, 2,2-bis(4-acryloxyethoxy-3,5-dibromophenyl)propane, bis(4-acryloxyethoxyphenyl)sulfone, bis(4-acryloxydiethoxyphenyl)sulfone, bis(4-acryloxypropoxyphenyl)sulfone, bis(4-acryloxyethoxy-3, 5-dibromophenyl)sulfone; compounds wherein the above described acrylate is changed to methacrylate, ethylenically unsaturated double bond containing compounds having at least two S atoms in a molecule as disclosed in Japanese Unexamined Patent Publication Nos. 247205 (1990) and 261808 (1990). The radical polymerizable compound may be used separately or as two or more combinations thereof.

The photopolymerizable compound (d) which polymerizes in the interference fringe exposure process, as the photosensitive composition used in the present invention, is contained in an amount of 5 to 600 parts by weight, preferably 20 to 250 parts by weight, more preferably 40 to 200 parts by weight, based on 100 parts by weight of a total weight of the matrix forming constituents of the compound (a), compound (b) and Michael reaction catalyst (c) which react in pre-reaction by heat. In case where the photopolymerizable compound is less than 5 parts, or more than 600 parts, maintaining of solid form by pre-reaction is difficult.

As a photopolymerizable compound (d) which undertakes a radical polymerization, the compound (b) containing in one molecule two or more groups which are at least one sort of an acrylate group and a methacrylate group may be used. In this context, the photopolymerizable compound (d) and compound (b) may be the same compound or different compounds in use.

When the same compound as compound (b) and photopolymerizable compound (d) is used, the photosensitive composition for volume interference hologram recording used in the present invention comprises:
(a) a compound having at least one active methylene group in one molecule or a compound having at least two active methine groups in one molecule;
(c) a Michael-reaction catalyst;
(e) a photopolymerization initiator composition; and
(f) a compound containing in one molecule two or more groups which are at least one sort of an acrylate group and a methacrylate group, (hereafter, referred as “compound (f)”). In this context, the compound (f) covers both a compound containing in one molecule two or more groups which are nucleophilicly added by a carbanion generating from an active methylene group or an active methine group, and photopolymerizable compound.

As the compound (f), the above mentioned compound (b) can be used. As the compound (f), a monomer with fluorene skeleton is preferably used.

In this case, a reaction amount of compound (f) in pre-reaction, that is, an amount reacted as a compound containing in one molecule two or more groups which are nucleophilicly added by a carbanion generating from an active methylene group or an active methine group, is determined by equivalent number of active methylene groups and/or active methine group in the compound (a), corresponding to equivalent number of acrylate groups and/or methacrylate groups of the compound (f). In the pre-reaction, the compound (a) is addition-reacted with a portion of the compound (f), and then the remaining of the compound (f) is polymerized by exposure for interference fringe.

Generally, for the photosensitive composition for volume hologram recording, page data recording needs refractive index modulation. In a conventional photosensitive composition for volume hologram recording, two or more kinds of resins each having different refractive index are used to provide refractive index modulation, and therefore the composition has to contain such two or more kinds of resins having a different refractive index. In contrast, the photosensitive composition of the present invention does not need such two or more resins with different refractive index. For example, when the compound (b) and the photopolymerizable compound (d) are same, the compounds themselves have the same refractive index, of course. However, the product obtained by nucleophilic addition of compound (a) to compound (b) (Michael addition) in the pre-reaction is different in refractive index with a product obtained by polymerizing in the subsequent interference fringe exposure. Therefore, without the use of resins with different refractive index, refractive index modulation occurs and record of interference fringe can be conducted. Also, since the reaction product in pre-reaction and the product photopolymerized in interference fringe exposure process have the same skeleton structure, the compatibility of both products is so excellent that interference fringe recording with low noise can be achieved.

When the photosensitive composition for volume hologram recording used by the present invention contains the compound (a), the Michael reaction catalyst (c), the photopolymerization initiator composition (e), and the compound (f), each constituent contains in weight percent; compound (a) 3 to 60%, preferably, 8 to 30%, Michael reaction catalyst (c) 0.01 to 5%, preferably 0.1 to 1%, photopolymerization initiator (e) 0.05 to 15%, preferably 0.5 to 6%, and compound (f) 40 to 97%, preferably 60 to 90%. Each of all constituents is used within the total weight of 100%. When each constituent is used out of the above range, maintaining of solid form by pre-reaction may is difficult.

Photopolymerization initiator composition (e), in interference fringe exposure process, by irradiation of a laser or a light having excellent coherence which has a specific wavelength, initiates to photopolymerize compound (d) or remaining compound (f). In the case that the photopolymerizable compound (d) or the compound (f) is radical polymerizable compound, the photopolymerization initiator composition (e) includes a photoradical polymerization initiator. And, in the case that the photopolymerizable compound (d) or the compound (f) is a cationic polymerizable compound, the photopolymerization initiator composition (e) includes a photocationic polymerization initiator.

The photoradical polymerization initiator is art known, but not limited, as described in U.S. Pat. Nos. 4,766,055, 4,868,092 4,965,171, Japanese Unexamined Patent Publication Nos. 151024 (1979), 15503 (1983), 29803 (1983), 189340 (1984), 76735 (1985), 28715 (1989), Japanese Patent Application No. 5569 (1991), and Proceeding of Conference on Radiation Curing Asia, p. 461-477, (1988).

Examples of the photoradical polymerization initiators are diaryliodnium salts, or 2,4,6-substituted-1,3,5-triazines (triazine compounds), titanocene compounds as described in Japanese Unexamined Patent Publication Nos. 29803 (1983), 287105 (1989), and Japanese Patent Application No. 5569 (1991). Examples of the above diaryliodonium salts include chloride, bromide, tetrafluoroborate, hexafluorophosphate, hexafluoroarsenate, hexafluoroantimonate, trifluoromethanesulfonate, 9,10-dimetoxyanthracene-2-sulfonate, and the like (e.g. diphenyliodonium, 4,4′-dichchlorodiphenyliodonium, 4, 4′-dimethoxydihenyliodonium, 4,4′-ditertiary-butyidiphenyliodonium, 3, 3′-dinitrodiphenyliodonium). Examples of 2,4,6-substituted-1,3, 5-triazins include 2-methyl-4,6-bis(trichloromethyl)-1,3,5-triazine, 2,4, 6-tris(trichloromethyl)-1,3,5-triazine, 2-phenyl-4,6-bis(trichloromethyl)-1, 3,5-triazine, 2,4-bis(trichloromethyl)-6-(p-methoxyphenylvinyl)-1,3, 5-triazine, 2-(4′-methoxy-1′-naphthyl)-4,6-bis(trichloromethyl)-1,3, 5-triazine and the like. Examples of titanocene compounds include bis(cyclopentadienyl)-di-chloro-titanium, bis(cyclopentadienyl)-di-phenyl-titanium, bis(cyclopentadienyl)-bis(2,3,4,5,6-pentafluorophenyl)titanium, bis(cyclopentadienyl)-bis(2,6-difluorophenyl)titanium, bis(methylcyclopentadienyl)-bis(2,3,4,5,6-pentafluorophenyl)titanium, bis(methylcyclopentadienyl)-bis(2,6-difluorophenyl)titanium, bis(cyclopentadienyl)-bis[2,6-difluoro-3-(2-(1-pyl-1-yl)ethyl)phenyl]titanium, bis(cyclopentadienyl)-bis[2,6-difluoro-3-((1-pyl-1-yl)methyl)phenyl]titanium, bis(methylcyclopentadienyl)-bis[2,6-difluoro-3-(1-pyl-1-yl)phenyl]titanium, bis(cyclopentadienyl)-bis[2,6-difluoro-3-((2,5-dimetyl-1-pyl-1-yl)methyl) phenyl]titanium, bis(cyclopentadienyl)-bis[2,6-difluoro-3-((3-trimethsilyl-2,5-dimethyl-1-pyl-1-yl)methyl)phenyl]titanium, bis(cyclopentadienyl)-bis[2,6-difluoro-3-(2,5-bis(morphnylmethyl)-1-pyl-1-yl) methyl)phenyl]titanium, bis(cyclopentadienyl)-bis[2,6-difluoro-4-((2,5-dimethyl-1-pyl-1-yl)methyl) phenyl]titanium, bis(cyclopentadienyl)-bis[2,6-difluoro-3-methyl-4-(2-(1-pyl-1-yl)ethyl) phenyl]titanium, bis(cyclopentadienyl)-bis[2,6-difluoro-3-(1-methyl-2-(1-pyl-1-yl)ethyl)phenyl]titanium, bis(cyclopentadienyl)-bis[2,6-difluoro-3-(6-(9-carbazoyl-9-yl)hexyl)phenyl]titanium, bis(cyclopentadienyl)-bis[2,6-difluoro-3-(3-(4,5,6,7-tetrahydro-2-methy-1-in dole-1-yl)propyl)phenyl]titanium, bis(cyclopentadienyl)-bis[2,6-difluoro -3-((acetylamino)methyl)phenyl]titanium, bis(cyclopentadienyl)-bis[2,6-difluoro-3-(2-(propionylamino)ethyl)phenyl]tit anium, bis(cyclopentadienyl)-bis[2, 6-difluoro-3-(4-(vivaroylamino)butyl)phenyl]titanium, bis(cyclopentadienyl)-bis[2, 6-difluoro-3-(2-(2,2-dimethylpentanoylamino)ethyl)phenyl]titanium, bis(cyclopentadienyl)-bis[2,6-difluoro-3-(3-(benzoylamino)propyl)phenyl]titanium, bis(cyclopentadienyl)-bis[2,6-difluoro-3-(2-(N-allylmethylsulfonylamino)ethyl)phenyl]titanium, bis(cyclopentadienyl)bis(2,6-difluoro-3-(1-pyl-yl)phenyl)titanium, and the like. These may be used separately or as two or more combinations thereof.

The photocationic polymerization initiator is art-known, but not limited, as described in UV Curing; Science and Technology, pp. 23-76, edited by S. Peter Pappras; A Technology Marketing Publication, and Comments Inorg. Chem. B. Klingert, M. Riediker and A. Roloff, Vol. 7, No. 3, pp. 109-138, (1988).

Examples of the photocation polymerization initiator are diaryliodonium salts, triarylsulfonium salts and the like. Examples of the diaryliodonium salts include, tetrafluoroborate, hexafluorophosphate, hexafluoroarsenate, hexafluoroantimonate, trifluoromethanesulfonate, 9, 10-dimethoxyanthracene-2-sulfonate, of iodonium as exemplified in the above radical photopolymerization initiator. Examples of the triarylsulfonium salts include tetrafluoroborate, hexafluorophosphate, hexafluoroarsenate, hexafluoroanitimonate trifluoromethanesulfonate, 9, 10-dimethoxyanthracene-2-sulfonate, of sulfonium, such as triphenylsulfonium, 4-tertial-butylphenylsulfonium, tris(4-methylphenyl)sulfonium, tris(4-methoxyphenyl) sulfonium, 4-thiophenyltriphenylsulfonium. These may be used separately or as two or more combinations thereof.

Photopolymerization initiator composition (e) may include a sensitizer in combination with the polymerization initiator. As the sensitizer, a color compound is normally used for absorbing a visible laser light. However, when a colorless and transparent recording layer is ultimately required for volume hologram, it is preferred to use a cyanine dye as disclosed in Japanese Unexamined Patent Publication Nos. 29803 (1983), 287105 (1989), and Japanese Patent Application No. 5569 (1991). The cyanine dye normally tends to decompose by light. Accordingly, the dye in volume hologram is decomposed by post-exposure in the present invention, or by standing under room light or sun light for several hours or days, which results in no absorption of visible light to give colorless and transparent volume hologram.

Examples of the cyanine dyes include anhydro-3, 3′-dicarboxymethyl-9-ethyl-2,2′-thiacarbocyanine betaine, anhydro-3-carboxymetyl-3′, 9-diethyl-2,2′-thiacarbocyanine betaine, 3,3′, 9-triethyl-2,2′-thiacarbocyanine iodine salt, 3,9-diethyl-3′-carboxymethyl-2, 2′-thiacarbocyanine iodine salt, 3,3′, 9-triethyl-2,2′-(4,5,4′,5′-dibenzo) thiacarbocyanine iodine salt, 2-[3-(3-ethyl-2-benzothiazolidene)-1-propenyl]-6-[2-(3-ethyl-2-benzothiazolidene)ethylideneimino]-3-ethyl-1,3,5-thiadiazolium iodine salt, 2-[[3-allyl-4-oxo-5-(3-n-propyl-5,6-dimetyl-2-benzothiazolidene)-ethylidene-2-thiazolidene]methyl]3-ethyl-4,5-diphenylthiazolinium iodine salt, 1,1′,3,3,3′,3′-hexamethyl-2,2′-indotricarbocyanine iodine salt, 3,3′-diethyl-2,2′-thiatricarbocyanine perchlorate, anhydro-1-ethyl-4-methoxy-3′-carboxymethyl-5′-chloro-2,2′-quinothiacyanine betaine, anhydro-5,5′-diphenyl-9-ethyl-3,3′-disulfopropyloxacarbocyaninehydroxide triethylamine salt, and the like. One or more compounds of them may be used.

When volume hologram is not necessary to be colorless and transparent, acene dye as described in Japanese Unexamined Patent Publication Nos. 184311 (1994), 317907 (1994), 511302 (2000), or coumarin dye in Japanese Unexamined Patent Publication No. 180946 (1988) may be used. Examples of the acene dyes include anthracene, 9-anthracenemethanol, 1,4-dimethoxyanthracene, 9,10-dimemethoxyanthracene, 9,10-dimethylanthrace, 9-phenoxymethylanthracene, 9,10-bis(n-butylethynyl) anthracene, 9,10-bis(n-trimethylsilylethynyl) anthracene, 1,8-dimethoxy-9,10-bis(phenylethynyl)anthracene, 5,12-bis(phenylethynyl)-naphthacene, and the like. These compounds can sensitize photopolymerization initiator with an argon laser light of 514 nm, and with a YAG laser light of 532 nm. It is preferred to use initiator such as 1,8-dimethoxy-9,10-bis(phenylethynyl)anthracene or 5,12-bis(phenylethynyl)-naphthacene. Examples of coumarin dye include 7-dimetylamino-3-(2-tyenoyl)coumarin, 7-diethylamino-3-(2-furoyl)coumarin, 7-diethylamino-3-(2-tenoyl)coumarin, 7-pyrolydinyl-3-(2-tenoyl)coumarin, 7-pyrodinyl-3-(2-benzofuroyl)coumarin, 7-diethylamino-3-(4-dimethylaminocinnamoyl)coumarin, 7-diethylamino-3-(4-diethylaminocinnamoyl)coumarin, 7-diethylamino-3-(4-diphenylaminocinnamoyl)coumarin, 7-diethylamino-3-(4-dimethylaminocinnamilideneacetyl) coumarin, 7-diethylamino-3-(4-diethylaminocinnamilideneacetyl) coumarin, 7-diethylamino-3-(4-diphenyllaminocinnamilideneacetyl) coumarin, 7-diethylamino-3-(2-benzofuroyl)coumarin, 7-diethylamino-3-[3-(9-durolidyl)acryloyl]coumarin, 3,3′-carbonylbis(7-methoxycoumarin), 3,3′-carbonylbis(5,7-dimethoxycoumarin), 3,3′-carbonylbis(6-methoxycoumarin), 3,3′-carbonylbis(7-dimethylaminocoumarin), 3,3′-carbonylbis(7-diethylaminocoumarin), 3-carbetoxy-7-(diethylamino)coumarin, and the like.

The photopolymerization initiator composition (e) contains, on the basis of 100 parts by weight of the photopolymerizable compound (d), 0.1 to 90 parts by weight, preferably 3 to 60 parts by weight in the photosensitive composition used in the present invention. In the case that an amount of the photopolymerization initiator composition (e) is less than 0.1 part, curing ability is not sufficient that hologram recording may be difficult. On the other hand, more than 90 parts may cause the curing of a lower part to be difficult.

When the compound (f) is used, the photopolymerization initiator composition (e) contains, on the basis of 100 parts by weight of the compound (f), preferably 0.05 to 50 parts by weight, more preferably 1 to 30 parts by weight in the photosensitive composition used in the present invention. In the case that an amount of the photopolymerization initiator composition (e-1) is less than 0.05 parts, curing ability is sufficient or hologram recording may be difficult. On the other hand, more than 30 parts may cause the curing of a lower part to be difficult.

In the photosensitive composition for volume hologram recording, there may be included according to necessities, organic solvents, heat-polymerization inhibitors, silane coupling agents, plasticizer, color agents, leveling agents, defoaming agents, etc.

The photosensitive composition used in the present invention may be prepared in an ordinary way. In any of the embodiments, the preparation may be done by mixing the above mentioned components and an optional component, as it is, or being formulated with solvents if necessary, in a dark, for example, using a high-speed stirrer. As proper solvents, the examples include ketone solvents such as methyl ethyl ketone, acetone, cyclohexanone; ester solvents such as ethyl acetate, butyl acetate, ethylene glycol diacetate; aromatic solvents such as toluene, xylene; cellosolve solvents such as methyl cellosolve, ethyl cellosolve, butyl cellosolve; alcohol solvents such as methanol, ethanol, propanol; ether solvents such as tetrahydrofuran, dioxane; halogen solvents such as dichloromethane, chloroform; etc. When solvents are used, they may be removed from the photosensitive composition under vacuum or the like in a pre-reaction of injection processing explained hereto later.

Manufacturing Method of Volume Hologram Recording Medium

A recording layer of a volume hologram recording medium is made by using the photosensitive composition as prepared above.

The photosensitive composition in the present invention can be adjusted into a low viscosity suitable for injection processing. By doing this, the photosensitive composition in the present invention is injected into a defined space with a given depth to form a recording layer. The defined space with a given depth means a defined space from which no leaking occurs in the case of low viscosity of photosensitive composition in the present invention.

FIG. 1 illustrates a basic structure for manufacturing a volume hologram recording medium. The basic structure is composed of a pair of substrates (2) and (3) and two side members (4) and (5) having small and large circular shapes. The substrates (2) and (3) have a disc shape with a circular pore. The substrates (2) and (3) are made of glass or transparent resin. At least one of the first substrate (2) and the second substrate (3) is transparent, because transparency is required in a side of receiving-light and transparency of the other side is not necessary.

The side members (4) and (5) are applied for keeping a given distance between the first substrate (2) and the second substrate (3), to form a space forming a recording layer with a thickness (depth). The thickness is preferably more than 200 μm and less than 1000 μm. The side member (4) is applied to fit each outer periphery (2a) and (3a) of the first substrate (2) and the second substrate (3). The side members (4) have a cut (4a) through which the photosensitive composition in the present invention can be injected. If necessary, another cut (4b) which is located apart from a cut (4a) may be made. An excess of the photosensitive composition injected can be discharged through the cut (4b).

Materials for the side members (4) and (5) can be anyone that is known to the art, such as photocurable or heat curable resin. Resin for the resin substrate may be also used. In a similar way of the inorganic thin layer on the substrate in the present invention, inorganic thin layer may also be applied on a side member. The inorganic thin layer applied on a side member provides oxygen and water cut-off at the side part to protect effectively the volume hologram recording layer. The method of applying an inorganic thin layer on a side member is a similar method, for example, deposition as used for the method on a resin plate.

Side member may be applied by separately pre-formed side members (4) and (5) as shown in FIG. 1. A separately pre-formed side member may be called a spacer. As shown in FIG. 2, side members (14) and (15) are single-piece formed circularly along the outer and inner peripheries of the first substrate (13), when the second substrate (12) are matched with the first substrate (13), these side members (14) and (15) may keep a distance uniform in thickness of a recording layer forming space.

As a method for injecting photosensitive composition into such a basic recording layer forming space, an appropriate method conducted widely can be used. In this way, the recording layer with a uniform thickness can be formed.

In another method for injecting the photosensitive composition in the present invention as shown in FIG. 3, the photosensitive composition is injected into a recording layer forming space composed of the first substrate (13), side members (14) and (15), and then a substrate is laminated, by facing the upper surface of the photosensitive composition for volume hologram recording. In this method, after injecting the photosensitive composition, a defoaming is carried out before the substrate being laminated. When the photosensitive composition contains solvent, the solvent may be removed before the substrate being laminated.

FIGS. 1 to 3 particularly illustrate for a basic construction for manufacturing volume hologram recording medium in shape of circular desks, the method of the present invention is not limited to circular disk, but various shapes, for example card shape, of recording medium can be manufactured.

The photosensitive composition thus formed is increased in viscosity by heating or, in case where light pre-reaction is possible, irradiation of light (pre-reaction process). The pre-reaction is conducted by nucleophilic addition of the compound (a) to the compound (b) to polymerize the compounds (a) and (b) or by nucleophilic addition of the compound (a) to a portion of compound (f) to polymerize. This results in viscosity increase. In the case of viscosity increase by photoirradiation the radical photopolymerizable compound polymerize. By these reactions, when the recording layer of the photosensitive composition stands in a horizontal position, the photosensitive composition is hardened so as to maintain a solid form without leaking the photosensitive composition. The pre-reaction gives the recording layer a solid form, as the results, an excellent interference fringe recording with an excellent recording retention can be obtained. The volume hologram recording medium can be provided for recording interference fringe under a state increased in viscosity.

In the pre-reaction process, on heating, it is preferable to heat at 40 to 130° C. for 5 to 12 hr. In the pre-reaction process, on irradiation of light, it is preferable to irradiate light of a wavelength of 350 to 500 nm for 5 to 240 sec. But, these conditions in the pre-reaction process are modified according to a resin substrate used, within no adverse influence to the resin substrate.

On exposure of a laser light or a light having excellent coherence (e.g. 400 to 700 nm) to a photosensitive composition for volume hologram recording, interference fringe is recorded inside a recording layer, by polymerizing of a cationic polymerizable compound and/or radical polymerizable compound. By the present invention, in this stage, a refraction light by the interference fringe recorded is obtained to provide a hologram.

After the interference fringe exposure process, further, a post exposure process can be included by irradiation of a light having low coherence to a photosensitive composition to polymerize a remaining unhardened compound. Particularly, by irradiation of a light capable to polymerize a remaining unhardened compound (e.g. a wavelength of 200 to 600 nm), the remaining unreacted compound can be polymerized. In addition, before the post exposure process, by treating a recording layer with heat or infrared light, changes such as refraction efficiency, a peak wavelength of refraction light, a half width, and the like can be brought.

The present invention also provides a volume hologram recording medium in which either of the pair of substrate has an organic thin layer on at least one side of the substrate. This embodiment will be explained as follow.

Volume Hologram Recording Medium

Volume hologram recording medium by the present invention comprises:
a volume hologram recording layer; a first and a second substrates sandwiching the recording layer; a side member fixing peripheries of the recording layer and keeping a given distance between the first and the second substrates, wherein the first and the second substrates are resin substrates; each of the first and the second substrates has at least one inorganic thin layer on its surface facing the recording layer or the rear surface.

Volume Hologram Recording Layer

A volume hologram recording layer composed of volume hologram recording medium is formed by a photosensitive composition for volume hologram recording. The volume hologram recording layer by the present invention is the viscosity-increased layer of the photosensitive composition for volume hologram recording by a light exposure or heating. “Viscosity increase” herein means that the photosensitive composition for volume hologram recording is reacted by light irradiation or heat to enhance viscosity so as to maintain a solid form of the recording layer. The case of viscosity increase by light exposure or heating is that the components consisting of photosensitive composition for volume hologram recording, containing ethylenically unsaturated double bond such as acrylate group or methacrylate group react, for example.

As an embodiment of photosensitive composition for volume hologram recording in order to form a volume hologram recording layer, there listed is a part of components containing in the composition causing viscosity increase by light exposure or heating. As an embodiment of a photosensitive composition for volume hologram recording, the photosensitive composition comprises:
(a) a compound having at least one active methylene group in one molecule or a compound having at least two active methine groups in one molecule (compound (a));
(b) a compound containing in one molecule two or more groups which are nucleophilicly added by a carbanion generating from an active methylene group or an active methine group (compound (b));
(c) a Michael-reaction catalyst;
(d) a photopolymerizable compound; and
(e-1) a photopolymerization initiator composition,
   wherein the photosensitive composition for volume hologram recording is increased in viscosity by heating.

In the above explained photosensitive composition, the pre-reaction for viscosity increase is heat-polymerization, but in another embodiment of a photosensitive composition for volume hologram recording, the pre-reaction of viscosity increase is conducted by light exposure to react a portion of the composition. This type of photosensitive composition for volume hologram recording comprises:
(d-1) a cationic polymerizable compound;
(d-2) a radical polymerizable compound containing acrylate group or methacrylate group;
(e-2) a photopolymerization initiator composition including (i) a photopolymerization initiator; being sensitized by a laser beam or a light having excellent coherence which has a specific wavelength for interference fringe exposure, to polymerize at least one sort of cationic polymerizable compound (d-1) and radical polymerizable compound (d-2); and (ii) a pre-reaction initiator; being sensitized by a light having the other wavelength than one using for interference fringe exposure, to polymerize a radical polymerizable compound (d-2) in the pre-reaction.

A photopolymerization initiator (ii) included in the photopolymerization initiator composition (e-2), which is sensitized by a light having the other wavelength than one using for interference fringe exposure, to polymerize a radical polymerizable compound (d-2) in the pre-reaction. At least some part of a radical polymerizable compound is polymerized in the pre-reaction by irradiation to a light having the other wavelength than one using for the interference fringe exposure process. Thereby viscosity is increased, which can keep a solid form without leaking the composition when the photosensitive layer composed of the photosensitive composition stands in a horizontal position.

The pre-reaction polymerization initiator (ii) preferably includes one or more compounds selected from the group consisting of titanocene compound, monoacylphosphine oxide, bisacylphosphine oxide, and a combination of bisacylphosphine oxide and α-hydroxyketone. Titanocene compound, monoacylphosphine oxide, bisacylphosphine oxide, or a combination of bisacylphosphine oxide and α-hydroxyketone, is the compound which has each a maximum absorption wavelength in the range from near-ultraviolet to visible lights. With one or more the compound included in the photosensitive composition, viscosity can be increased by irradiation of a light in the pre-reaction process.

As the photopolymerization initiator (i) which is sensitized by a laser beam or a light having excellent coherence which has a specific wavelength for interference fringe exposure, to polymerize at least one sort of cationic polymerizable compound (d-1) and radical polymerizable compound (d-2), at least one of the above radical photopolymerization initiator and cationic polymerization initiator can be used. A photopolymerization initiator composition (e-2) preferably includes sensitizer. The sensitizer above described can be used.

The photopolymerization initiator composition (e-2) preferably includes diaryliodonium salt; sensitizer; and one or more compounds selected from the group consisting of titanocene compound, monoacylphosphine oxide, bisacylphosphine oxide, and a combination of bisacylphosphine oxide and α-hydroxyketone. By using the photopolymerization initiator composition (e-2), it becomes possible to obtain the volume hologram recording medium with an excellent interference fringe recording.

As a titanocene compound which is preferably used as a pre-reaction initiator (ii), the titanocene compound described in the photopolymerization initiator composition (e) can be used.

As the monoacyl phosphine oxide which is preferably used as a pre-reaction initiator (ii), there can be used well known monoacyl phosphine oxide. It includes the monoacyl phosphine oxide as described in Japanese Examined Patent Publication Nos. 8047 (1985) and 40799 (1988). Examples thereof are: isobutylyl-methylphosphinic acid methyl ester, isobutylyl-phenylphosphinic acid methyl ester, vivaroyl-phenylphosphinic acid methyl ester, 2-ethylhexanoyl-phenylphosphinic acid methyl ester, vivaroyl-phenylphosphinic acid isopropyl ester, p-tolylphenylphosphinic acid methyl ester, o-tolyl-phenylphosphinic acid methyl ester, 2,4-dimethylbenzoyl-phenylphosphinic acid methyl ester, p-tert-butyl benzoyl-phenylphosphinic acid isopropyl ester, acryloyl-phenylphosphinic acid methyl ester, isobutyl-diphenylphosphine oxide, 2-ethylhexanoyl-diphenylphosphine oxide, o-tolyl-diphenylphosphine oxide, p-tert-butylbenzoyl-diphenyl phosphine oxide, 3-pyridylcarbonyl-diphenylphosphine oxide, acryloyl-diphenylphosphine oxide, benzoyl-diphenylphosphine oxide, vivaroyl-phenylphosphinic acid vinyl ester, adipoyl-bis-diphenylphosphine oxide, vivaroyldiphenylphosphine oxide, p-tolyl-diphenylphosphine oxide, 4-(tert-butyl)benzoyl-diphenylphosphine oxide, terephthaloyl-bis-diphenylphosphine oxide, 2-methylbenzoyl-diphenylphosphine oxide, versatoyl-diphenylphosphine oxide, 2-methyl-2-ethylhexanoyl-diphenylphosphine oxide, 1-methyl-cyclohexanoyl-diphenylphosphine oxide, vivaroyl-phenylphosphinic acid methyl ester, vivaroyl-phenylphosphinic acid isopropyl ester an the like. As the bisacylphosphine oxide, there can be used well known bisacylphosphine oxide. For example, there are bisacylphosphine oxide compound as described in Japanese Unexamined Patent Publication Nos. 101686 (1991), 345790 (1993), 6-298818 (1994). The examples include: bis(2,6-dichlrobenzoyl)-phenylphosphine oxide, bis(2,6-dichlrobenzoyl)-2,5-dimethylphenyl phosphine oxide, bis(2,6-dichlrobenzoyl)-4-ethoxyphenylphosphine oxide, bis(2,6-dichirobenzoyl)-4-propylphenylphosphine oxide, bis(2,6-dichlrobenzoyl)-2-naphtylphosphine oxide, bis(2,6-dichlrobenzoyl)-1-naphtylphosphine oxide, bis(2,6-dichlorobenzoyl)-4-chlolphenylphosphine oxide, bis(2,6-dichirobenzoyl)-2,4-dimethoxyphenylphosphine oxide, bis(2,6-dichirobenzoyl)-decylphosphine oxide, bis(2,6-dichirobenzoyl)-4-octylphenylphosphine oxide, bis(2,4,6-trimethylbenzoyl)phenylphosphine oxide, bis(2,4,6-trimethylbenzoyl)-2,5-dimethylphenylphosphine oxide, bis(2,6-dichlro-3,4,5-trimethylbenzoyl)-4-ethoxyphenylphosphine oxide, bis(2-methyl-1-naphthoyl-2,5-dimethlphenylphosphine oxide, bis(2-methyl-1-naphthoyl)-4-ethoxyphenylphosphine oxide, bis(2-methyl-1-naphthoyl)-2-naphtylphosphine oxide, bis(2-methyl-1-naphthoyl)-4-proprylphenylphosphine oxide, bis(2-methyl-1-naphthoyl)-2,5-dimethylphenylphosphine oxide, bis(2-methoxy-1-naphthoyl)-4-ethoxyphenylphosphine oxide, bis(2-chloro-1-naphtoyl)-2,5-dimethylphenylphosphine oxide, bis(2,6-dimethoxybenzoyl)-2,4,4-trimethylpentylphosphine oxide, and the like. Examples of the α-hydroxyketones include 1-[4-(2-hydroxyethoxy)-phenyl]-2-hydroxy-2-methyl-1-propan-1-one, 2-hydroxy-2-methyl-1-phenyl-propane-1-one, 1-hydroxy-cyclohexyl-phenyl-ketone and the like.

In the photopolymerization initiator composition (e-2), each constituent preferably contains, weight percentage based on total photopolymerization initiator composition (e-2), photopolymerization initiator (i) 5 to 90% by weight (particularly 8 to 80% by weight), sensitizer 0.1 to 15% by weight (particularly 0.5 to 10% by weight), and pre-reaction polymerization initiator (ii) 2 to 40% by weight (particularly 4 to 20% by weight).

The photopolymerization initiator composition (e-2) contains, on the basis of 100 parts by weight of the cationic photopolymerizable compound (d-1), 1 to 60 parts by weight, preferably 4 to 40 parts by weight in the photosensitive composition used in the present invention. In the case that the photopolymerization initiator composition (e-2) contains less than 1 part, curing ability is not sufficient that hologram recording can be difficult. On the other hand, more than 60 parts may cause the curing of a lower part to be difficult. The cationic photopolymerizable compound (d-1) contains, on the basis of 100 parts by weigh of the radical photopolymerizable compound (d-2), 15 to 600 parts by weight, preferably 40 to 250 parts by weight, more preferably 50 to 200 parts by weight in the photosensitive composition used in the present invention. When the cationic photopolymerizable compound (d-1) is less than 15 parts, or more than 600 parts, maintaining a solid form in pre-reaction by light exposure may become difficult.

In these embodiments, there is not necessarily to separate a reaction of interference fringe exposure process from pre-reaction. It is proper enough that the pre-reaction process allows the radical polymerizable compound (d-2) to polymerize at least partly for the viscosity increase, and the polymerization of the pre-treatment, if any, may be occurred again in the interference fringe exposure process. It is because that even such case can provide an excellent fixation of interference fringe recording.

The photosensitive composition used in the present invention may be prepared in an ordinary way. In any of the embodiments, the preparation may be done by mixing the above mentioned components and an optional component, as it is, or being formulated with solvents if necessary, in a dark, for example, using a high-speed stirrer. As proper solvents, the examples include ketone solvents such as methyl ethyl ketone, acetone, cyclohexanone; ester solvents such as ethyl acetate, butyl acetate, ethylene glycol diacetate; aromatic solvents such as toluene, xylene; cellosolve solvents such as methyl cellosolve, ethyl cellosolve, butyl cellosolve; alcohol solvents such as methanol, ethanol, propanol; ether solvents such as tetrahydrofuran, dioxane; halogen solvents such as dichloromethane, chloroform; etc. When solvents are used, they may be removed from the photosensitive composition under vacuum or the like in a pre-reaction of injection processing explained hereto later.

In the photosensitive composition for volume hologram recording, there may be included according to necessities, organic solvents, heat-polymerization inhibitors, silane coupling agents, plasticizer, color agents, leveling agents, defoaming agents, etc.

The First Substrate and the Second Substrate

The first substrate and the second substrate comprising volume hologram recording medium in the present invention are a pair of substrates sandwiching a recording layer. The first and the second substrates can be resin substrates in this embodiment. This makes the volume hologram recording medium light in weight and improvement in shock-resistance. The resin substrates is transparent substrate made of one sort of the resins or polymer alloys containing any one of the resins being selected from the examples: polycarbonate, acrylate resin, methacrylate resin, polystyrene, vinyl chloride resin, epoxy resin, polyester, amorphous polyolefin, norbornen thermoplastic resin, polyether imide, polyether nitrile, polyether ketone, polymethlpentene, polyacrylate, polyether sulfone, and polyphenylenesulfide. Of these resins, a substrate thereof with a low birefringence is preferable. At least one of the first and second substrates is transparent, which makes interference fringe exposure possible to record data in the recording layer for volume hologram recording medium. Therefore, either of the substrates, through which a light of interference fringe exposure passing, is transparent, the other substrate may be not necessarily transparent. The substrates with a thickness of 50 μm to 2 mm are preferable, and of 0.3 mm to 1 mm is more preferable.

Also, each of the first and the second substrates has at least one inorganic thin layer on its surface facing a recording layer or the rear surface. The inorganic layer may be applied on the surface facing the recording layer, or on the rear surface, and on the both of the surface. Inorganic compounds comprising the inorganic thin layer include metal, metal oxide, metal nitride and the like. Examples are metals such as silicon, aluminum, magnesium, tin, zinc, nickel, titanium etc., and nitride or oxide thereof. Metal oxide is preferable because it provides a high transparent thin layer. Examples of the metal oxide are silicon oxide, aluminum oxide, magnesium oxide and the like. This may be used separately or two or more mixtures thereof.

In the case of one inorganic thin layer on its surface facing a recording layer, substrate film layer may be applied on the inorganic thin layer. Applying the substrate film layer can avoid a direct contact to the volume hologram recording layer, which can use more inorganic compounds. Substrate capable of applying on the inorganic thin layer has no limitation except being transparent, however the film with a low birefringence is preferable for the same reason as the substrate. The examples of the film made of the materials include: polyolefin such as homopolymers or copolymers of ethylene, propylene, butene, and amorphous polyolefin such as cyclic polyolefin; polyester such as polyethylene terephthalate, polyethylene-2,6-naphthalate; polyamide such as nylon 6, nylon 66, nylon 12-copolymer nylon; partially hydrorized ethylene-vinylacetate copolymer (EVOH), polyimide, polyether imide, polysulfone, polyether sulfone, polyether ketone, polycarbonate (PC), polyvinylbutylar, polyarylate, fluoropolymer, acrylate resin and the like. Among of them, are preferable polyester, polyamide, polyolefin, partially hydrorized ethylene-vinylacetate copolymer, and polyester and polyamide are particularly preferable. The above substrate film is prepared by their known methods, and either undrawn film or drawn film is suitable, and drawn film is preferable. The laminated films are also suitable. The thickness of substrate film of 5 to 500 μm is preferable, 10 to 200 μm is more preferable.

In the case of no substrate film layer is applied on the inorganic thin layer laid on its surface facing a recording layer, it is preferable to use the inorganic compound which affects no adverse influence such as reacting with ingredients contained in the volume hologram recording layer.

By forming an inorganic thin layer on a substrate film layer, the inorganic thin layer may be formed on the volume hologram recording medium. As a method for the forming an inorganic thin layer on a substrate film layer, the similar method can be adopted as the method for forming an inorganic thin layer on a substrate. In this method of forming the inorganic thin layer, a direct contact way of the inorganic thin layer with the volume hologram recording layer may be used, and also direct contact way of the substrate film layer with the volume hologram recording layer may be used as well.

Silicon oxide is the most preferable inorganic compound comprising inorganic thin layer. Silicon oxide is highly transparent and also shows a high performance of oxygen cut-off and water cut-off. Moreover, it gives no adverse influence reacting with ingredient contained in a volume hologram recording layer.

Applying an inorganic thin layer on a resin substrate enhances the performance of oxygen cut-off and water cut-off of the resin substrate. For example, in forming a recording layer composed of photosensitive composition for volume hologram recording, by heating, compound (a) and compound (b) react, or compound (a) and part of compound (f) react to give viscosity increase, it is concerned that a Michael catalyst is deactivated by the presence of water in the recording layer (c). The deactivation prevents the progress of reaction between compound (a) and compound (b), or compound (a) and part of compound (f) and gives no good viscosity increase. In contract, a good viscosity increase is secured by blocking water thanks to the inorganic thin layer on the resin substrate.

When the compound (a) and compound (b) react, or the compound (a) and part of compound (f) react by heating to give viscosity increase, it is thought that a radical reaction and a Michael addition reaction also involve in the viscosity increase. In this case, by heating, generating radical from a radical photopolymerization initiator composition and, from a Michael reaction catalyst dependent on its sort via a substraction reaction of hydrogen from compound (a), resulting in a radical reaction to compound (b) or compound (f), in combination of a Michael addition reaction, the reaction proceeds partly to increase in viscosity. It is thought that the radical reaction may help to give a good viscosity increase. The radical reaction can be disturbed by the presence of oxygen. A good viscosity increase is secured by blocking oxygen thanks to the inorganic thin layer on the resin substrate.

In another embodiment, when in photosensitive composition for volume hologram recording forming a recording layer, by light exposure, in the case that a radical photopolymerizable compound (d-2) is polymerized to give viscosity increase. The radical polymerization can be disturbed by the presence of oxygen. In this case, lowering of the radical polymerization is prevented by blocking oxygen thanks to the inorganic thin layer on the resin substrate, which secures a good viscosity increase. Hereto light exposure corresponds to irradiation of light in pre-reaction with the other wavelength than a specific wavelength for interference fringe exposure.

In addition of the above effect, the inorganic thin layer on the resin substrate may contribute to the improvement of interference fringe recording on interference fringe exposure.

As the method for forming an inorganic thin layer on a resin substrate, there are deposition, vapor deposition, ion plating, spattering, CVD method and other methods. Moreover, by forming an inorganic thin layer on a resin film using deposition etc., and then laminating the film on a resin substrate, an inorganic thin layer can be formed on a resin substrate. The thickness of inorganic thin layer is preferably equal and more than 0.1 nm, more preferably equal or more than 1 nm. No sufficient oxygen cut-off and water cut-off may be obtained with less than 0.1 nm. The thickness of inorganic thin layer is preferably equal or less than 500 nm, more preferably equal or less than 30 nm. With more than 500 nm, transparency may be impaired by the inorganic thin layer applied in the side of light irradiation upon interference fringe exposure, to give not an excellent interference fringe recording.

Either of the first substrate or the second substrates may contain a reflection layer. The reflection layer is independent of the inorganic thin layer.

### EXAMPLES

The following examples further illustrate the present invention in detail but are not to be intended to limit the scope thereof. Here “part” represents by weight otherwise specified.

### Production Example 1

Production of Active Methylene Group-Containing Compound (M-1)

A reaction vessel was charged with 138 parts of methyl acetoacetate and 34 parts of dipentaerythritol and heated to 145° C. over one hour with introducing nitrogen gas. Methanol was removed in a decanter with stirring at 145° C. for one hour and then at 155° C. for 2 hours, until it was found that almost theoretical amount of methanol was removed. Thereafter, unreacted methyl acetoacetate was distilled out at 155° C. at a reduced pressure, to obtain an objective compound. The compound was determined to have at least 5.5 functional groups of active methylene group in one molecule (theoretical 6 groups).

### Production Example 2

Production of Active Methylene Group-Containing Compound (M-2)

A reaction vessel was charged with 102 parts of methyl acetoacetate and 35 parts of tris(2-hydroxyethyl)isocyanulate and heated to 145° C. over one hour with introducing nitrogen gas. Methanol was removed in a decanter with stirring at 145° C. for one hour and then at 155° C. for 2 hours, until it was found that almost theoretical amount of methanol was removed. Thereafter, unreacted methyl acetoacetate was distilled out at 155° C. at a reduced pressure, to obtain an objective compound. The compound was determined to have at least 2.9 functional groups of active methylene group in one molecule (theoretical 3 groups).

### Production Example 3

Production of Active Methylene Group-Containing Compound (M-3)

A reaction vessel was charged with 135 parts of methyl acetoacetate and 35 parts of trimethylol propane and heated to 145° C. over one hour with introducing nitrogen gas. Methanol was removed in a decanter with stirring at 145° C. for one hour, until it was found that almost theoretical amount of methanol was removed. Thereafter, unreacted methyl acetoacetate was distilled out at 155° C. at a reduced pressure, to obtain an objective compound. The compound was determined to have at least 3.7 functional groups of active methylene group in one molecule (theoretical 4 groups).

### Example A1

An example in which photopolymerizable compound (d) is radical poloymerizable compound.

Ingredients were as follow: 137 parts of the compound M-1 of Production Example 1 as the compound (a), 695 parts of 9,9-bis(4-acryloxydiethoxyphenyl)fluorine (BPFA) as the compound (b), 6 parts of tetrabutylammonium fluoride (TBA) as Michael reaction catalyst (c), 153 parts of 9,9-bis(4-acryloxydiethoxyphenyl)fluorine (BPFA) as the photopolymerizable compound (d) and 8 parts of CGI-784 (titanocene compound) available from Chiba Specialty Chemical Co. as the photopolymerization initiator (e). The photopolymerization initiator (e) was dissolved or dispersed in 100 parts of ethanol, into which 150 parts of acetone, the compound (a), the compound (b) and the catalyst (c) were added, followed by mixing and filtering to obtain a photosensitive composition.

Preparation of Hologram Evaluation Test Panel

After setting a film spacer of 500 μthick on the peripheries of a glass substrate having a coating of Al refractive layer, the photosensitive composition was applied on the glass plate to form a dried film of 500 μm and dried at 90° C. for 15 minutes to remove solvent. Another glass substrate with a glare resistant coating was pressed to the photosensitive layer to obtain a test panel.

Pre-Reaction

The test panel was heated at 60° C. for 9 hours to pre-react the photosensitive composition.

Evaluation of Hologram Characteristics

The test panel was employed to determine hologram characteristics. For the evaluation, a corinia holographic media analyzer (SHOT-1000 Ver. 2.1.0 available from Pulstic Co.) was employed. A page data was recorded by changing exposure pulse at a fixed exposure intensity of 2.0 mW and then read out after 30 seconds (1.0 mW×10 pulse) to determine a bit error rate (BER) and an average brightness (μm) from the read-out page data

One page data recording was about 30 KB data. The data was recorded as 0 being a dark point of the hologram and 1 being a light point of the hologram. The data bit error rate (BER) shows an error rate of 0 or 1 in the readout data. When the DER is 3×10⁻³, it corresponds to about 100 errors in data.

Sensitivity

An evaluation of sensitive of the hologram is conducted by determining an exposure pulse at which the BER is smallest. The number (P) the smaller, the more excellent the sensitivity. When the sensitivity is high, the hologram can record interference fringe with lower energy. This accelerates recording speed. In case where the data recording is conducted on a rotating disk, the sensitivity needs 100 P or more. A hologram having high sensitivity can be recorded by a low output laser, thus reducing a size of a device and its cost.

Brightness

An evaluation of brightness of a hologram is conducted by determining a largest μ on of page data, that is a calculated value at a readout exposure of 10 mW×10 P. In this context, the term “μ on” indicates an average of brightness of 1 (on) in the readout page data. The larger the μ on value, the brighter the hologram. When the brightness is high, the hologram can read the data with lower energy. This accelerates reading speed. A hologram having high brightness can be recorded by a low output laser, thus reducing a size of a device and its cost. In addition, high sensitive readout device is employed to divide the brightness which means to reduce brightness of one data. This enhances recording pile-up steps and capacity of date.

Retention of Record

An evaluation of retention of record of a hologram is conducted by determining a maximum time at which the record is at BER of 3×10⁻³. Concretely, data recording is conducted by a pulse at which the BER is smallest and left for a determined time. Thereafter, a reading out is conducted and subjected to an evaluation of BER, to measure a left time keeping the BER value of less than 3×10⁻³. The less the number or time, the better the retention of record, which makes it possible to retain data at large capacity recording. In the hologram recording, it is general that the recordation of interference fringe follows a post exposure to secure the recorded data in the hologram. When a large capacity data is recorded in the hologram, a time period from the recording of data to the post exposure to secure the date therein is prolonged so as to require high retention of record.

The results of the evaluation are shown in Table A1.

### Example A2

An example in which photopolymerizable compound (d) is radical poloymerizable compound.

Ingredients were as follow: 160 parts of the compound M-2 of Production Example 2 as the compound (a), 673 parts of 9,9-bis(4-acryloxydiethoxyphenyl)fluorine (BPFA) as the compound (b), 6 parts of tetrabutylammonium fluoride (TBA) as Michael reaction catalyst (c), 153 parts of 9,9-bis(4-acryloxydiethoxyphenyl)fluorine (BPFA) as the photopolymerizable compound (d) and 8 parts of CGI-784 (titanocene compound) available from Chiba Specialty Chemical Co. as the photopolymerization initiator (e). The photopolymerization initiator (e) was dissolved or dispersed in 100 parts of ethanol, into which 150 parts of acetone, the compound (a), the compound (b) and the catalyst (c) were added, followed by mixing and filtering to obtain a photosensitive composition.

A hologram evaluation test panel was prepared from the resulting photosensitive composition as generally described in Example A1 and subjected to the same evaluations as Example A1. The results are shown in Table A1.

### Example A3

An example in which photopolymerizable compound (d) is radical poloymerizable compound.

Ingredients were as follow: 146 parts of the compound M-3 of Production Example 3 as the compound (a), 686 parts of 9,9-bis(4-acryloxydiethoxyphenyl)fluorine (BPFA) as the compound (b), 6 parts of tetrabutylammonium fluoride (TBA) as Michael reaction catalyst (c), 153 parts of 9,9-bis(4-acryloxydiethoxyphenyl)fluorine (BPFA) as the photopolymerizable compound (d) and 8 parts of CGI-784 (titanocene compound) available from Chiba Specialty Chemical Co. as the photopolymerization initiator (e). The photopolymerization initiator (e) was dissolved or dispersed in 100 parts of ethanol, into which 150 parts of acetone, the compound (a), the compound (b) and the catalyst (c) were added, followed by mixing and filtering to obtain a photosensitive composition.

A hologram evaluation test panel was prepared from the resulting photosensitive composition as generally described in Example A1 and subjected to the same evaluations as Example A1. The results are shown in Table A1.

### Example A4

An example in which photopolymerizable compound (d) is cationic poloymerizable compound.

Ingredients were as follow: 146 parts of the compound M-3 of Production Example 3 as the compound (a), 686 parts of 9,9-bis(4-acryloxydiethoxyphenyl)fluorine (BPFA) as the compound (b), 6 parts of tetrabutylammonium fluoride (TBA) as Michael reaction catalyst (c), 153 parts of Cerokiside 2021 (difunctional alicyclic epoxy resin available from Daicel Chemical Industries, Co. Ltd.) as the photopolymerizable compound (d) and, as the photopolymerization initiator (e), a mixture of 5 parts of 9,10-bis(phenylethynyl) anthracene, 60 parts of diphenyliodonium hexafluoroantimonate and 5 parts of η⁵-cyclopentadienyl-η⁶-coumenyl-iron hexafluorophosphate. The photopolymerization initiator (e) was dissolved or dispersed in 100 parts of ethanol, into which 150 parts of acetone, the compound (a), the compound (b) and the catalyst (c) were added, followed by mixing and filtering to obtain a photosensitive composition.

A hologram evaluation test panel was prepared from the resulting photosensitive composition as generally described in Example A1 and subjected to the same evaluations as Example A1. The results are shown in Table A1.

### Example A5

An example in which photopolymerizable compound (d) is both radical polymerizable compound and cationic poloymerizable compound.

Ingredients were as follow: 146 parts of the compound M-3 of Production Example 3 as the compound (a), 686 parts of 9,9-bis(4-acryloxydiethoxyphenyl)fluorine (BPFA) as the compound (b), 6 parts of tetrabutylammonium fluoride (TBA) as Michael reaction catalyst (c), a mixture of 100 parts of 9,9-bis(4-acryloxydiethoxyphenyl)fluorine and 53 parts of Cerokiside 2021 (difunctional alicyclic epoxy resin available from Daicel Chemical Industries, Co. Ltd.) as the photopolymerizable compound (d) and, as the photopolymerization initiator (e), a mixture of 5 parts of 9,10-bis(phenylethynyl) anthracene, 60 parts of diphenyliodonium hexafluoroantimonate and 5 parts of η⁵-cyclopentadienyl-η⁶-coumenyl-iron hexafluorophosphate. The photopolymerization initiator (e) was dissolved or dispersed in 100 parts of ethanol, into which 150 parts of acetone, the compound (a), the compound (b) and the catalyst (c) were added, followed by mixing and filtering to obtain a photosensitive composition.

A hologram evaluation test panel was prepared from the resulting photosensitive composition as generally described in Example A1 and subjected to the same evaluations as Example A1. The results are shown in Table A1.

Separately from the above Examples, each photosensitive composition was prepared as generally described in each one of Examples A1 to A5, with exception that no organic solvent was added. The photosensitive compositions were easily defoamed and easily poured in a defined space for recording layer having 500 μm thickness. The resulting recording medium had no air foams.

### Comparative Example A1 (an Example Based on the Process of Japanese Unexamined Publication 352303 (1999))

Seven parts of CGI-784 (Chiba Specialty Chemicals Co.) as photopolymerization initiator was dissolved with 117 parts of 4-bromostyrene as photopolymerizable compound. The solution was mixed with 511 parts of polypropyleneglycol diglycidyl ether (molecular weight of about 400 (PPGDGE), 321 parts of pentaerythritol tetrakis(6-mercaptopropionate and 45 parts of tris(2,4,6-mdimethylaminomethyl)phenol (TDMAMP) as matrix component to form a photosensitive composition.

A hologram evaluation test panel was prepared from the resulting photosensitive composition as generally described in Example A1 and left for about one hour at room temperature to generate gelation by the copolymerization reaction of mercaptan and epoxy with a catalystic function of amine. It was then exposed to interference fringe as generally described in Example A1. The resulting hologram was subjected to the same evaluations as Example A1. The results are shown in Table A2.

### Comparative Example A2 (an Example Based on the Process of Japanese Unexamined Publication 105030 (1998))

A mixture of 597 parts of polytetrahydrofuran (molecular weight of about 2,000) and 132 parts of isophorone diisocyanate as matrix component was mixed for 10 minutes at room temperature. To the mixture, one part of dibutyltin dilaurate as curing accerelater and heated to 70° C., followed by cooling to 50° C. To the content, 77 parts of 4-hydroxymethylcyclohexeneoxide was added and heated to 80° C. The resulting mixture was deaerated under a reduced pressure and then cooled.

Separately, 8 parts of CGI-784 (Chiba Specialty Chemicals Co.) as photopolymerization initiator and 92 parts of phenoxyethyl acrylate were dissolved in 61 parts of isobornyl acrylate. The resulting mixture was mixed with the above obtained mixture at room temperature and cooled, to which 32 parts of trimethoxyboroxine was added.

A hologram evaluation test panel was prepared from the resulting photosensitive composition as generally described in Example A1 and heated to 90° C. for about 3 hours to cure the matrix forming components in the composition. It was then exposed to interference fringe and subjected post exposure. The resulting hologram was subjected to the same evaluations as Example A1. The results are shown in Table A2.

### Comparative Example A3 (an Example Based on the Process of Japanese Unexamined Publication 105030 (1998))

A mixture of 597 parts of polytetrahydrofuran (molecular weight of about 2,000) and 132 parts of isophorone diisocyanate as matrix component was mixed for 10 minutes at room temperature. To the mixture, one part of dibutyltin dilaurate as curing accerelater and heated to 70° C., followed by cooling to 50° C. To the content, 77 parts of 4-hydroxymethylcyclohexeneoxide was added and heated to 80° C. The resulting mixture was deaerated under a reduced pressure and then cooled.

Separately, 8 parts of CGI-784 (Chiba Specialty Chemicals Co.) as photopolymerization initiator was dissolved in 153 parts of 9,9-bis(4-acryloxydiethoxyphenyl)fluorine. The resulting mixture was mixed with the above obtained mixture at room temperature and cooled, to which 32 parts of trimethoxyboroxine was added.

A hologram evaluation test panel was prepared from the resulting photosensitive composition as generally described in Example A1 and heated to 90° C. for about 3 hours to cure the matrix forming components in the composition. It was then exposed to interference fringe and subjected post exposure. The resulting hologram was subjected to the same evaluations as Example A1. The results are shown in Table A2.

TABLE A1

| | Example | Example | Example | Example | Example |
|---|---|---|---|---|---|
| | A1 | A2 | A3 | A4 | A5 |
| Sensitivity | 50 | 20 | 10 | 20 | 5 |
| (P) | | | | | |
| Brightness | 3500 | 3000 | 3500 | 5000 | 3000 |
| Retention | More than | More than | More than | 30 min | 60 min |
| of record | 60 min | 60 min | 60 min | | |

TABLE A2

| | Comparative | Comparative | Comparative |
|---|---|---|---|
| | Example A1 | Example A2 | Example A3 |
| Sensitivity (P) | 200 | 1000 | 5000 |
| Brightness | 3000 | 160 | 500 |
| Retention of | 10 min | 3 min | 10 min |
| record | | | |

As is apparent from the above Examples, the volume hologram recording medium prepared from the photosensitive composition of the present invention shows superior in sensitivity, brightness and retention of record to Comparative Examples. The volume hologram recording medium of the present invention has high sensitivity and can be recorded by lower energy at high speed. It also has high brightness and can be recorded by lower energy and readout at high speed. Since it has high retention of record, it can store data having larger capacity.

### Example B1

Ingredients were as follow: 1600 parts of two-functional cyclic epoxy as a cationic polymerizable compound (d-1) (brand name: RM-2199 (CAT-1); manufactured by the Asahi Denka Kogyo Company); 800 parts of bis(4-acryoxydietoxyohenyl)methane (AEPM) as a radical polymerizable compound (d-2); 300 parts of 4, 4′-ditertial-butyldiphenylodonium hexafluorophosphate (DPI-I) in photopolymerization initiator composition (e-2); 5 parts of titanocene compound (brand name: Irgacure-784 (PI-1); manufactured by the Chiba Specialty Chemicals Company); 5 parts of 3, 9-diethyl-3′-carboxymethyl-2,2′-thiacarvoxyanion iodonium salt (DYE-1) as a sensitizer. DPI-1 operates as radical photopolymerization initiator and cationic photopolymerization initiator. The above constituent amount of photopolymerization initiator composition (e-2) was dissolved or dispersed to 500 parts of ethanol, to which 500 parts of acetone, the above cationic polymerizable compound (d-1) and radical polymerizable compound (d-2) were added, followed by mixing and filtering to obtain photosensitive composition. It was then condensed under vacuum to a solid-content of 85 to 90%.

Preparation of Hologram Evaluation Test Sheet

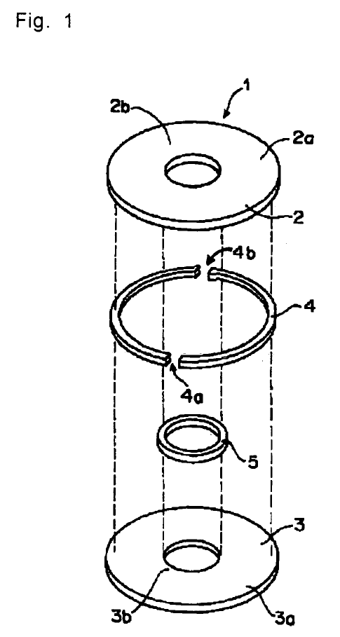

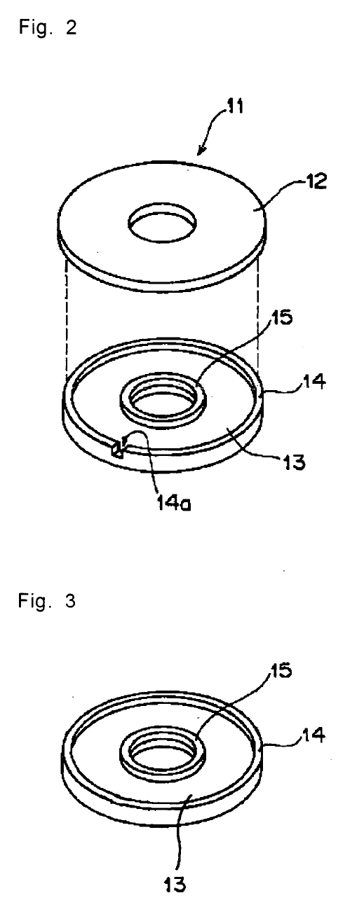

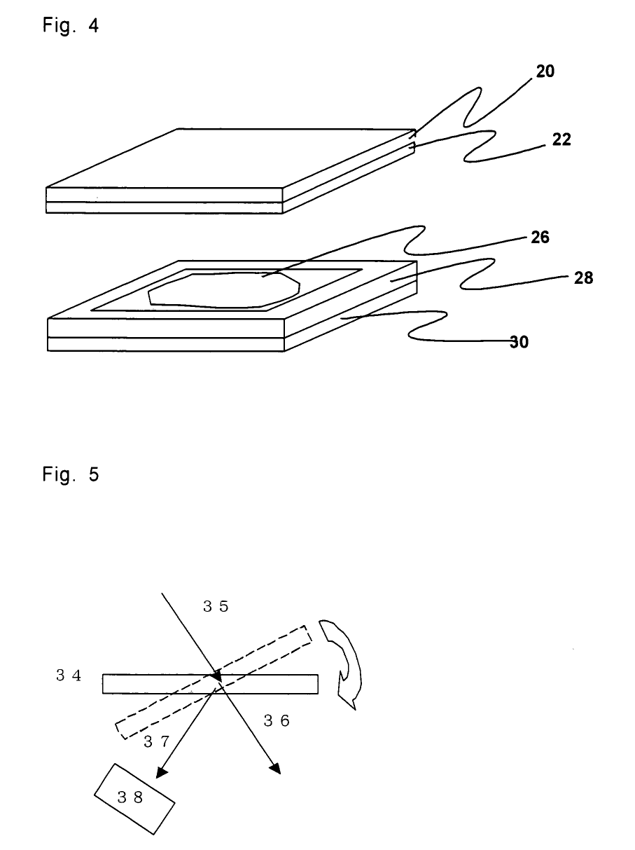

On a surface of resin substrate made of polycarbonate, inorganic thin layer of silicon oxide was formed by a vacuum deposition method. The thickness of the inorganic thin layer was 260 nm. After setting a spacer of 500 μm thick on the peripheries of a glass substrate of 4 cm×4 cm with 0.6 mm thick, 1.0 gram of the condensed photosensitive composition was weighed on the glass plate which was dried at 90° C. for 15 min in a hot air dryer, the solvent was eliminated for the photosensitive composition to be more than 97% of solid-content. The resin substrate was applied downwards to be 500 μm in thickness of the recording layer, for being prepared as an evaluation test plate. The substrate has the inorganic thin layer of silicon oxide on its surface facing to the photosensitive composition, so the inorganic thin layer and the photosensitive composition were contacted directly. A schematic diagram for preparation of evaluation test plate is shown in FIG. 4.

Irradiation of Light (Pre-Reaction)

Irradiation of a light was carried out by a separated light of 450 nm, combining a Xenon lamp with UV-cut filter of below 350 nm (brand name: UV-35; manufactured by the Toshiba Glass Company), interference filter (brand name: KL-45; manufactured by the Toshiba Glass Company) and infrared absorption filter (brand name: HAF-50S-30H; manufactured by the Sigma Khoki Company). A light intensity at the surface of a test sheet was 5.0 mW/cm², with the above wavelength and the test sheet was irradiated for 50 sec. The existence of white turbidity and maintaining of a solid form on the resin substrate were observed as the evaluation of the irradiated test sheet. The degree of maintaining a solid form was determined by fluidity of photo-sensitized layer in a perpendicular position of the test sheet.

Interference Fringe Exposure

On interference fringe exposure, a parallel light obtained by a semiconductor-excited YAG laser light of 532 nm being passed through a special filter was exposed to a test sheet in two incident light beams at plus and minus degree of 27° from the normal line to a test plate. FIG. 5 shows a schematic diagram of an optical system for interference exposure. Each of the beams was about 0.5 cm in diameter, a light intensity at the surface of a test sheet was 2.5 mW/cm², and exposure time was 10 sec.

Post Exposure

After interference fringe exposure, as post exposure, a light from a high-pressure mercury lamp (brand name: FL-1001-2; test apparatus for ultra-violet light exposure; manufactured by the Nippon Battery Company) was exposed to a test sheet for 30 sec. The existence of white turbidity was determined as the evaluation of photo-sensitized layer after post exposure.

Optical Characteristic Evaluation of Hologram

The evaluation of the hologram obtained was measured as the diffraction efficiency of a first diffraction light by using a semiconductor-excited YAG laser light of 532 nm with an incident light beam at plus degree of 27°. For the evaluation of optical element, an optical system was used as shown in FIG. 5. With changing the angle of detection light by a mere rotation of a test sheet, angle dependence against the incident angles was measured and the maximum of diffraction efficiency was evaluated.

### Example B2

Silicon oxide-deposited PET film (brand name: Tech-barrier #12, a thickness of 12 μm; manufactured by the Mitsubishi Plastics Company) was applied to a 0.6 mm thick polycarbonate substrate coated with UV-cure type adhesive, in such a way that the silicon oxide deposited layer on the outside was laminated to make a direct contact to the photosensitive layer. Except that, the procedure of Example B1 was repeated for preparation of evaluation test sheet, and test was carried out.

### Example B3

Using the compound M-1 (Production Example 1), a photosensitive compound was prepared. This is an example of use of a radial polymerizable compound as photopolymerizable compound (d). 137 parts of the obtained compound containing active methylene group, 695 parts of 9,9-bis(4-acryoxydiethoxypheny)fluorene (BPFA) as a compound (b), 6 parts of tetrabutylammoniumfluoride (TBA) as a Michael reaction catalyst (c), 153 parts of 9,9-bis(4-acyroxy diethoxyphenol)fluorene (BPFA) as a photopolymerizable compound (d), 5 parts of 9, 10-bis(phenylthynyl)anthracene as a photopolymerizable compound (e-1), 60 parts of diphenyliodonium hexthafluoroantimonate, and 5 parts of η⁵-cyclopenntandienyl-η⁶-cumenyl-iron-hexafluorophosphate mixture were used. The above photopolymerization initiator composition (e-1) was dissolved/dispersed in 100 parts of ethanol, and 150 parts of acetone, the above compound (a), compound (b) and Michael reaction catalyst (c) were added, stirred, and filtered to obtain the photosensitive composition.

Using the obtained photosensitive composition, a hologram evaluation test sheet was prepared according to Example B1. The procedure of Example B1 was repeated except that heating at 60° C. for 9 hr was done instead of light exposure. The results are shown in Table B1.

### Example B4

Silicon oxide deposited PET film (brand name: Tech-barrier #12, a thickness of 12 μm; manufactured by the Mitsubishi Plastics Company) was applied to a 0.6 mm thick polycarbonate substrate coated with UV-cure type adhesive, in such a way that the silicon oxide deposited layer on the outside was laminated to make a direct contact to the photosensitive layer. Except that, the procedure of Example B3 was repeated for preparation of evaluation test sheet, and test was carried out. The results are shown in Table B2.

### Example B5

Silicon oxide deposited PET film (brand name: Tech-barrier #12, a thickness of 12 μm; manufactured by the Mitsubishi Plastics Company) was applied to a 0.6 mm thick polycarbonate substrate coated with UV-cure type adhesive, in such a way that the silicon oxide deposited layer on the inside was laminated not to make a direct contact to the photosensitive layer Except that, the procedure of Example B3 was repeated for preparation of evaluation test sheet, and test was carried out. The results are shown in Table B2.

### Example B6

Aluminum oxide deposited PET film (brand name: BARRIALOX VM-PET1011HG, a thickness of 12 μm; manufactured by the Toyo Metalizing Company) was applied to a 0.6 mm thick polycarbonate substrate coated with UV-cure type adhesive, in such a way that the aluminum oxide deposited layer on the inside was laminated not to make a direct contact to the photosensitive layer. Except that, the procedure of Example B3 was repeated for preparation of evaluation test sheet, and test was carried out. The results are shown in Table B2.

Using the resin substrate of Example B6, without PET film layer, the substrate being applied with a direct contact of the inorganic thin layer to the photopolymerizable composition was heated at 60° C. for 9 hr, the viscosity was increased, however, no excellent recording was obtained.

### Comparative Example B1

Except that the polycarbonate substrate used in Example B1 was used without forming an inorganic thin layer, the procedure of Example B1 was repeated for preparation of evaluation test sheet, and test was carried out. The results are shown in Table B3.

### Comparative Example B2

Except that the polycarbonate substrate used in Example B3 was used without forming an inorganic thin layer, the procedure of Example B3 was repeated for preparation of evaluation test sheet, and test was carried out. The results are shown in Table B3.

### Comparative Example B3

Except that the polycarbonate substrate used in Example B2 was used with only PET film and no forming an inorganic thin layer, the procedure of Example B2 was repeated for preparation of evaluation test sheet, and test was carried out. The results are shown in Table B3.

### Comparative Example B4

Except that the polycarbonate substrate used in Example B4 was used with only PET film and no forming an inorganic thin layer, the procedure of Example B4 was repeated for preparation of evaluation test sheet, and test was carried out. The results are shown in Table B4.

### Comparative Example B5 (Blank)

Except that the polycarbonate substrate used in Example B1 was replaced by glass substrate, the procedure of Example B1 was repeated for preparation of evaluation test sheet, and test was carried out. The results are shown in Table B4. The glass substrate has neither inorganic thin film nor PET film layer.

### Comparative Example B6 (Blank)

Except that the polycarbonate substrate used in Example B3 was replaced by glass substrate, the procedure of Example B3 was repeated for preparation of evaluation test sheet, and test was carried out. The results are shown in Table B4. The glass substrate has neither inorganic thin film nor PET film layer.

TABLE B1

| | Example B1 | Example B2 | Example B3 |
|---|---|---|---|
| Metal compound | Silicon oxide | Silicon oxide | Silicon oxide |
| composing | | | |
| inorganic thin layer | | | |
| Resin constituent | Cationic | Cationic | Compound |
| contained in | polymerizable | polymerizable | containing |
| photosensitive | compound (d-1) | compound (d-1) | active |
| composition | & Radical | & Radical | methylene |
| composing | polymerizable | polymerizable | group (a), |
| recording layer | compound (d-2) | compound (d-2) | compound (b), |
| | | | and |
| | | | photopolymerizable |
| | | | compound |
| | | | (d) |
| Layer laid on resin | Inorganic thin | Inorganic thin | Inorganic thin |
| substrate | layer | layer (direct | layer |
| | | contact)/PET film | |
| White turbidity of | Nothing | Nothing | Nothing |
| resin substrate | | | |
| Maintaining a solid | Present | Present | Present |
| form | | | |
| Diffraction | 15% | 9% | 11% |
| efficiency | | | |

TABLE B2

| | Example B4 | Example B5 | Example B6 |
|---|---|---|---|
| Metal compound | Silicon oxide | Silicon oxide | Aluminum oxide |
| composing | | | |
| inorganic thin layer | | | |
| Resin constituent | Compound | Compound | Compound |
| contained in | containing active | containing | containing |
| photosensitive | methylene group | active | active |
| composition | (a), compound (b), | methylene | methylene |
| composing | and | group (a), | group (a), |
| recording layer | photopolymeriz-able | compound (b), | compound (b), |
| | compound(d) | and | and |
| | | photopolymerizable | photopolymerizable |
| | | compound(d) | compound(d) |
| Layer laid on resin | Inorganic thin | Inorganic thin | Inorganic thin |
| substrate | layer (direct | layer | layer |
| | contact)/PET film | (noncontact)/ | (noncontact)/ |
| | | PET film | PET film |
| White turbidity of | Nothing | Nothing | Nothing |
| resin substrate | | | |
| Maintaining a solid | Present | Present | Present |
| form | | | |
| Diffraction | 7% | 6% | 5% |
| efficiency | | | |

TABLE B3

| | Comparative | Comparative | Comparative |
|---|---|---|---|
| | Example B1 | Example B2 | Example B3 |
| Metal compound | — | — | — |
| composing | | | |
| inorganic thin layer | | | |
| Resin constituent | Cationic | Compound | Cationic |
| contained in | polymerizable | containing active | polymerizable |
| photosensitive | compound (d-1) | methylene group | compound (d-1) |
| composition | & Radical | (a), compound | & Radical |
| composing | polymerizable | (b), and | polymerizable |
| recording layer | compound (d-2) | photopolymerizable | compound (d-2) |
| | | compound(d) | |
| Layer laid on resin | — | — | PET film |
| substrate | | | |
| White turbidity of | Nothing | Present | Nothing |
| resin substrate | | | |
| Maintaining a solid | Viscosity | Viscosity | Viscosity |
| form | increased, but | increased, but | increased, but |
| | without a solid | without a solid | without a solid |
| | form | form | form |
| Diffraction | Cannot be | Cannot be | Cannot be |
| efficiency | evaluated | evaluated | evaluated |

TABLE B4

| | Comparative | Comparative | Comparative |
|---|---|---|---|
| | Example B4 | Example B5 | Example B6 |
| Metal compound | — | — | — |
| composing | | | |
| inorganic thin | | | |
| layer | | | |
| Resin constituent | Compound | Cationic | Compound |
| contained in | containing active | polymerizable | containing |
| photosensitive | methylene group | compound (d-1) & | active |
| composition | (a), compound | Radical | methylene |
| composing | (b), and | polymerizable | group (a), |
| recording layer | photopolymerizable | compound (d-2) | compound (b), |
| | compound(d) | | and |
| | | | photopolymerizable |
| | | | compound(d) |
| Layer laid on | PET film | Glass plate | Glass plate |
| resin substrate | | | |
| White turbidity of | Nothing | Nothing | Nothing |
| resin substrate | | | |
| Maintaining a | Viscosity | Present | Present |
| solid form | increased, but | | |
| | without a solid | | |
| | form | | |
| Diffraction | Cannot be | 17% | 8% |
| efficiency | evaluated | | |

* Glass plate was used instead of resin plate in Comparative Examples B1 and B2.

From the evaluation results, in the volume hologram recording medium comprised of resin substrate with inorganic thin layer, viscosity for the resin substrate was increased in the same level as that for glass substrate.

The volume hologram recording medium by the present invention, being composed of resin substrate not of glass plate, which presents light weight, and excellent shock-resistance, and excellent precision of interference fringe recording. The volume hologram recording medium by the present invention is the mass-capacity and movable recording medium with an excellent carrying performance, thus valuable industrially.

1. A volume hologram recording photosensitive composition comprising:
(a) a compound having at least one active methylene group in one molecule or a compound having at least two active methine groups in one molecule;
(b) a compound containing in one molecule two or more groups which are nucleophilicly added by a carbanion generating from an active methylene group or an active methine group;
(c) a Michael-reaction catalyst;
(d) a photopolymerizable compound; and
(e) a photopolymerization initiator composition.

2. The volume hologram recording photosensitive composition, according to claim 1, wherein the photopolymerizable compound (d) is a radical polymerizable compound.

3. The volume hologram recording photosensitive composition according to claim 1, wherein the photopolymerizable compound (d) is a radical polymerizable compound with one or more ethylenically unsaturated double bonds in a molecule.

4. The volume hologram recording photosensitive composition according to anyone of claims 1 to 3, wherein the compound (b) is a monomer with fluorene skeleton.

5. A volume hologram recording photosensitive composition comprising:
(a) a compound having at least one active methylene group in one molecule or a compound having at least two active methine groups in one molecule;
(c) a Michael-reaction catalyst;
(e) a photopolymerization initiator composition; and
(f) a compound containing in one molecule two or more groups which are at least one sort of an acrylate group and a methacrylate group.

6. The volume hologram recording photosensitive composition, according to claim 5, wherein the compound (f) is a monomer with fluorene skeleton.

7. The volume hologram recording photosensitive composition, according to claim 1 or 5, wherein the photopolymerization initiator composition (e) is one or more compounds selected from the group consisting of titanocene compound, diaryliodonium salt, and triarylsufonium salt.

8. The volume hologram recording photosensitive composition, according to claim 1 or 5, wherein the Michael-reaction catalyst is one or more compounds selected from the group consisting hydroxide of alkali metal, alkoxide of alkali metal, onium salt, tertiary amine, guanidine, amidine and tertiary phosphine.

9. The volume hologram recording photosensitive composition, according to claim 8, wherein the Michael-reaction catalyst contains quaternary ammonium halide as onium salt.

10. The volume hologram recording photosensitive composition, according to claim 1, which is used for producing a volume hologram recording medium.

11. A process for producing a volume hologram recording medium, comprising the following steps:
an injection step wherein the volume hologram recording photosensitive composition of claim 1 is injected into a defined space having a given depth, and
a pre-reaction step wherein the composition is heated to addition-react either the compound (a) with the compound (b) or the compound (a) with a portion of the compound (f).

12. The process for producing a volume hologram recording medium according to claim 11, wherein the defined space is composed of
a pair of substrates sandwiching a volume hologram recording layer; and
a side member fixing peripheries of the recording layer and keeping a given distance between the first and the second substrates,

13. The process for producing a volume hologram recording medium according to claim 11, wherein the injection step is divided into
a coating step wherein the volume hologram recording photosensitive composition is coated on one of the paired substrates to form a photosensitive composition layer, and
a laminating step wherein the other paired substrate is laminated on the photosensitive composition layer.

14. A process for producing a volume hologram recording medium, comprising the following steps:
a coating step wherein the volume hologram recording photosensitive composition of claim 1 is coated on one of a pair of substrates to form a photosensitive composition layer,
a laminating step wherein the other paired substrate is laminated on the photosensitive composition layer, and
a pre-reaction step wherein the composition is heated to addition-react either the compound (a) with the compound (b) or the compound (a) with a portion of the compound (f).

15. The process for producing a volume hologram recording medium according to claim 14, further including an interference fringe exposure step, after the pre-reaction step, wherein the photosensitive composition layer is subjected to exposure to a laser light having specific wavelength or light having excellent coherence to polymerize the photopolymerizable compound (d) or the remaining compound (f).

16. The process for producing a volume hologram recording medium according to claim 15, further including a post-exposure step, after the interference fringe exposure step, wherein light having lower coherence is radiated onto the resulting photosensitive composition layer to polymerize the unreacted compound.

17. A volume hologram recording medium obtained by claim 11, 14 or 15.

18. Volume hologram recording medium comprising:
a volume hologram recording layer;
a first substrate and a second substrate sandwiching the recording layer;
a side member fixing peripheries of the recording layer and keeping a given distance between the first and the second substrates,
wherein the first and the second substrates are resin substrates;
each of the first and the second substrates has at least one inorganic thin layer on its surface facing the recording layer or the rear surface;
and the volume hologram recording layer is a viscosity-increased layer of photosensitive composition for volume hologram recording by light exposure or heating.

19. The volume hologram recording medium according to claim 18, wherein the volume hologram recording layer is obtained by a photosensitive composition for volume hologram recording, the photosensitive composition comprises:
(a) a compound having at least one active methylene group in one molecule or a compound having at least two active methine groups in one molecule;
(b) a compound containing in one molecule two or more groups which are nucleophilicly added by a carbanion generating from an active methylene group or an active methine group;
(c) a Michael-reaction catalyst;
(d) a photopolymerizable compound; and
(e-1) a photopolymerization initiator composition,
wherein the recording layer is a viscosity-increased layer resulted from a reaction of compound (a) and compound (b) by heating.

20. The volume hologram recording medium according to claim 19, wherein the photosensitive composition for volume hologram recording is increased in viscosity by a radical polymerization by light exposure or heating.

21. The volume hologram recording medium according to claim 19, wherein the photopolymerizable compound (d) is a radical polymerizable compound with one or more ethylenically unsaturated double bonds in a molecule.

22. The volume hologram recording medium according to claim 19, wherein the compound (b) is a monomer with fluorene skeleton.

23. The volume hologram recording medium according to claim 18, wherein the volume hologram recording layer is obtained by a photosensitive composition for volume hologram recording, the photosensitive composition comprises:
(a) a compound having at least one active methylene group in one molecule or a compound having at least two active methine groups in one molecule;
(c) a Michael-reaction catalyst;
(e-1) a photopolymerization initiator composition; and
(f) a compound containing in one molecule two or more groups which are at least one sort of an acrylate group and a methacrylate group,
wherein the recording layer is a viscosity-increased layer resulted from a reaction of compound (a) and part of compound (f) by heating.

24. The volume hologram recording medium according to claim 18,
wherein the volume hologram recording layer is obtained by a photosensitive composition for volume hologram recording, the photosensitive composition comprises:
(d-1) a cationic polymerizable compound;
(d-2) a radical polymerizable compound;
(e-2) a photopolymerization initiator composition including (i) a photopolymerization initiator; being sensitized by a laser beam or a light having excellent coherence which has a specific wavelength for interference fringe exposure, to polymerize at least one sort of cationic polymerizable compound (d-1) and radical polymerizable compound (d-2); and (ii) a pre-reaction initiator; being sensitized by a light having the other wavelength than one using for interference fringe exposure, to polymerize a radical polymerizable compound (d-2) in pre-reaction,
wherein the recording layer is a viscosity-increased layer resulted from a polymerization of compound (d-2) by a light having the other wavelength than one using in interference fringe exposure process.

25. The volume hologram recording medium according to claim 24, wherein the photopolymerization initiator composition (e-2) contains diaryliodonium salt; sensitizer; and one or more compounds selected from the group consisting of titanocene compound, monoacylphosphine oxide, bisacylphosphine oxide, and combination of bisacylphosphine oxide and α-hydroxyketone.

26. The volume hologram recording medium according to claims 18, wherein the inorganic thin layer is a film of metal oxide.

27. The volume hologram recording medium of claim 18, wherein the inorganic thin layer is films of one or more metal oxide selected from the group consisting of silicon oxide, aluminum oxide, and magnesium oxide.

28. A manufacturing method for volume hologram recording medium comprising:
injection process which a photosensitive composition for volume hologram recording is injected into a space defined by a pair of a first substrate and a second substrate, and a side member keeping a given distance between the first and the second substrates being sandwiched; and a pre-reaction process in which the photosensitive composition for volume hologram recording is treated by light exposure or by heating,
wherein each of the first and the second substrates has at least one inorganic thin layer on its surface facing the recording layer or the rear surface; and
the photosensitive composition for volume hologram recording is increased in viscosity of by light exposure or heating.

29. The manufacturing method for volume hologram recording medium according to claim 28, wherein the photosensitive composition for volume hologram recording is increased in viscosity resulted from a radical polymerization by light exposure or heating.

30. The manufacturing method for volume hologram recording medium according to claim 28, wherein the photosensitive composition for volume hologram recording comprises:
(a) a compound having at least one active methylene group in one molecule or a compound having at least two active methine groups in one molecule;
(b) a compound containing in one molecule two or more groups which are nucleophilicly added by a carbanion generating from an active methylene group or an active methine group;
(c) a Michael-reaction catalyst;
(d) a photopolymerizable compound; and
(e-1) a photopolymerization initiator composition,
wherein the photosensitive composition is increased in viscosity resulted from a reaction of compound (a) and compound (b) by heating by heating.

31. The manufacturing method for volume hologram recording medium according to claim 30, wherein the compound (b) is a monomer with fluorene skeleton.

32. The manufacturing process for volume hologram recording medium according to claim 28, wherein the photosensitive compound for volume hologram recording comprises:
(a) a compound having at least one active methylene group in one molecule or a compound having at least two active methine groups in one molecule;
(c) a Michael-reaction catalyst;
(e-1) a photopolymerization initiator composition; and
(f) a compound containing in one molecule two or more groups which are at least one sort of an acrylate group and a methacrylate group,
wherein said photosensitive compound is increased in viscosity resulted from a reaction of compound (a) and part of compound (f) by heating.

33. The manufacturing method for volume hologram recording medium according to claim 28, wherein after pre-reaction, the method further comprises an interference fringe exposure process for photopolymerizable compound (d) or remaining compound (f) to polymerize by a laser beam or a light having excellent coherence which has a specific wavelength.

34. The manufacturing method for volume hologram recording medium according to claim 28, wherein the photosensitive composition for volume hologram recording comprises:
(d-1) a cationic polymerizable compound;
(d-2) a radical polymerizable compound;
(e-2) a photopolymerization initiator composition including (i).a photopolymerization initiator; being sensitized by a laser beam or a light having excellent coherence which has a specific wavelength for interference fringe exposure, to polymerize at least one sort of cationic polymerizable compound (d-1) and radical polymerizable compound (d-2); and (ii) a pre-reaction initiator; being sensitized by a light having the other wavelength than one using for the interference fringe exposure, to polymerize a radical polymerizable compound (d-2) in the pre-reaction,
wherein the photosensitive compound is increased in viscosity resulted from a polymerization of radical polymerizable compound (d-2) by a light having the other wavelength than one using in interference fringe exposure process.

35. The manufacturing method for volume hologram recording medium according to claim 34 wherein the photopolymerization initiator composition (e-2) contains diaryliodonium salt; sensitizer; and one or more compounds selected from titanocene compound, monoacylphosphine oxide, bisacylphosphine oxide, and combination of bisacylphosphine oxide and α-hydroxyketone.

36. The manufacturing method for volume hologram recording medium according to claim 34 or claim 35 wherein after pre-reaction process, the method further comprises an interference fringe exposure process for at least one sort of cationic polymerizable compound (d-1) and radical polymerizable compound (d-2) to polymerize by a laser beam or a light having excellent coherence which has a specific wavelength.

37. The manufacturing method for volume hologram recording medium according to claim 28, wherein the inorganic thin layer is a film of metal oxide.

38. The manufacturing method for volume hologram recording medium according to claim 28, wherein the inorganic thin layer is films of one or more metal oxide selected from the group consisting of silicon oxide, aluminum oxide, and magnesium oxide.

39. A volume hologram recording medium obtained from the manufacturing method for volume hologram recording medium according to claim 28.
